(19) United States
(12) Patent Application Publication
(10) Pub. No.: US 2026/0252637 A1
(43) Pub. Date: Aug. 27, 2026

(54) SYSTEM

(71) Applicant: SoftBank Group Corp., Tokyo (JP)

(72) Inventor: Haruka GOTO, Tokyo (JP)

(73) Assignee: SoftBank Group Corp., Tokyo (JP)

(21) Appl. No.: 19/539,043

(22) Filed: Feb. 13, 2026

(30) Foreign Application Priority Data
Feb. 21, 2025 (JP) 2025-027045

(51) Int. Cl. G06F 16/951; G06F 40/30

(52) U.S. Cl. CPC G06F 16/951; G06F 40/30

(57) ABSTRACT

The system according to the embodiment comprises a collection unit, a shaping unit, an answering unit, and a generation unit. The collection unit collects user attribute information and past purchase tendencies. The shaping unit shapes product description text based on the information collected by the collection unit. The answering unit generates answers to user questions based on the product description text shaped by the shaping unit. The generation unit generates a post-purchase installation image based on the answer generated by the answering unit.

### CROSS-REFERENCE TO RELATED APPLICATION

The present application claims priority to and incorporates by reference the entire contents of Japanese Patent Application No. 2025-027045 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult to provide high-quality customer service based on user attribute information and past purchase tendencies.

### SUMMARY OF THE INVENTION

The system according to the embodiment comprises a collection unit, a shaping unit, an answering unit, and a generation unit. The collection unit collects user attribute information and past purchase tendencies. The shaping unit shapes product description text based on the information collected by the collection unit. The answering unit generates answers to user questions based on the product description text shaped by the shaping unit. The generation unit generates a post-purchase installation image based on the answer generated by the answering unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### [First Embodiment]

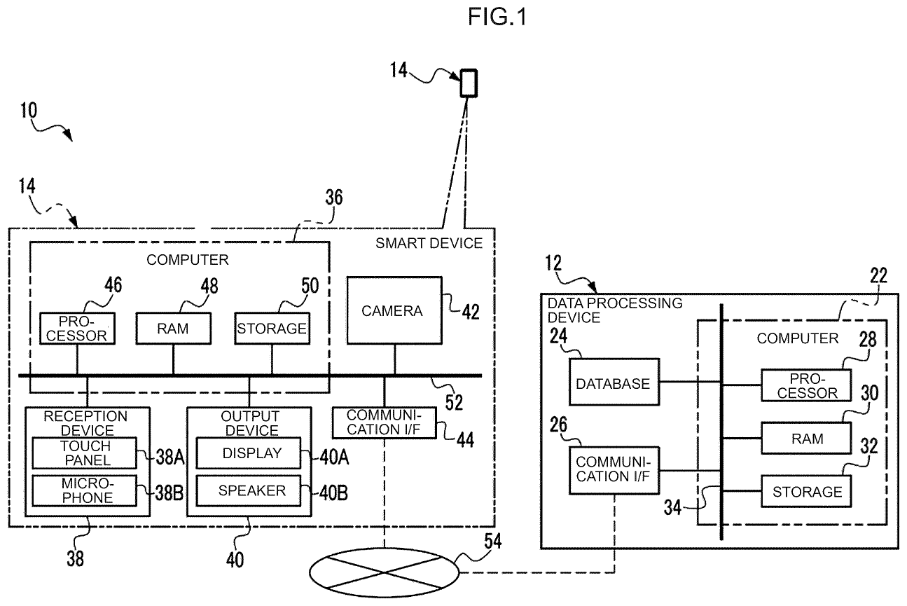

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

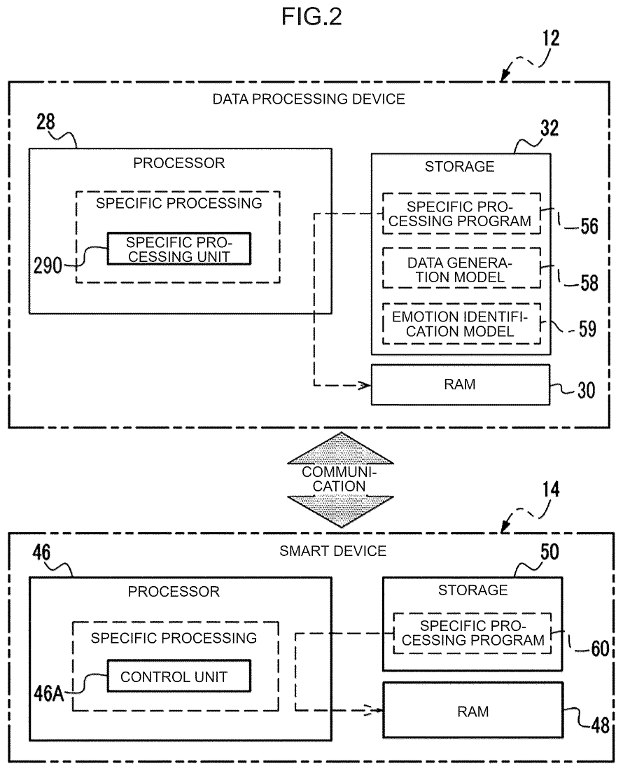

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE OF THE EMBODIMENT

The customer service system according to the embodiment of the present invention is a system that utilizes generative AI to provide high-quality customer service tailored to user needs. This customer service system shapes product description text using generative AI based on user attribute information and past purchase tendencies, collects user requests, and provides answers and explanations to questions in a chat format. Furthermore, generative AI generates post-purchase installation images. For example, attribute information such as user age, gender, interests, and data of products previously purchased are collected and analyzed by generative AI. For young female users, the description text for fashion items can be shaped to be more attractive. Next, generative AI collects user requests and provides answers and explanations to questions in a chat format. For example, when a user asks about a specific product, the system provides functional explanations and filtering for that product. Generative AI generates appropriate answers to user questions and provides them in a chat format, allowing users to receive real-time answers to their questions. Furthermore, generative AI generates post-purchase installation images. For example, when a user purchases furniture, an image showing the furniture installed in the user's room can be generated. Generative AI generates installation images based on photos of the user's room and dimension data. This allows users to check the installation image of a product before purchase. Through this mechanism, high-quality customer service tailored to user needs is realized, improving user satisfaction. For example, when a user asks about a specific product, functional explanations and filtering enable the user to find the optimal product. Additionally, by generating post-purchase installation images, users can check the installation image before purchase, which increases purchase motivation and is expected to improve sales. Thus, the customer service system can realize high-quality customer service tailored to user needs and improve user satisfaction. Specifically, this customer service system comprises multiple modules (collection unit, shaping unit, answering unit, generation unit), and by having each unit operate in coordination, it achieves advanced data analysis and personalized response generation that are difficult to realize with conventional human customer service. The system collects user attribute information (e.g., age, gender, interests as categorical, numerical, and text data) and past purchase tendencies (e.g., product ID, purchase date, amount, category, frequency as time-series data) via the collection unit, preprocesses these through vectorization, normalization, and one-hot encoding, and inputs them to generative AI (such as transformer-based large language models or multimodal generative models). Examples of input include user attribute vectors ([25, 0, 1, 0, 1, . . . ]), purchase history tensors (time-series arrays of [product ID, purchase date, amount, . . . ]), room images (RGB image tensors, size 256×256×3), and dimension data (numerical arrays). Generative AI integrates these diverse inputs and outputs product description text (natural language text, e.g., “This sofa is compact and ideal for single women in their 20s”), question answering (e.g., “What is the power consumption of this refrigerator?”→“Annual power consumption is 120 kWh”), and installation images (e.g., images compositing the purchased furniture into the user's room photo, in PNG/JPEG format). Output examples include text (UTF-8 encoded), images (Base64 encoded), and scores (e.g., recommendation score 0.85). These outputs are passed to subsequent chat interfaces and image display modules and presented to users in real time. In particular, for installation image generation, image generation models (e.g., conditional diffusion models or GANs) are used to accurately composite room and furniture images, allowing users to visually confirm the actual installation image before purchase. As a technical effect, this system automatically generates optimized product descriptions, responses, and installation images for each user, greatly improving personalization, satisfaction, and purchase motivation compared to conventional template-based explanations and uniform responses. Furthermore, by combining AI-based high-dimensional feature extraction, multivariate analysis, natural language generation, and image generation, the system not only automates processing but also improves response accuracy, generation speed, data management efficiency, and overall system scalability. Application fields include virtual customer service for e-commerce sites, online consultations for electronics retailers, installation simulations for furniture sales, personalized recommendations for fashion e-commerce, and pre-image presentations for home renovations. These technical improvements are significant in that they realize non-conventional high-dimensional data processing, rule-based generation, and multimodal reasoning by computers, rather than mere automation of human tasks.

The customer service system according to the embodiment comprises a collection unit, a shaping unit, an answering unit, and a generation unit. The collection unit collects user attribute information and past purchase tendencies. User attribute information includes, for example, age, gender, and interests. The collection unit collects attribute information such as user age, gender, and interests. Additionally, the collection unit can collect data of products previously purchased by the user. For example, the collection unit collects data such as the types, frequency, and amounts of products previously purchased by the user. The shaping unit shapes product description text based on the information collected by the collection unit. The shaping unit, for example, uses generative AI to shape product description text based on the collected data. Generative AI may utilize technologies such as natural language generation models or template-based generation. For example, the shaping unit uses generative AI to shape product description text based on user attribute information and past purchase tendencies. The answering unit generates answers to user questions based on the product description text shaped by the shaping unit. The answering unit, for example, uses generative AI to generate answers to user questions and provides them in a chat format. Generative AI can generate appropriate answers to user questions and provide them in a chat format. For example, the answering unit uses generative AI to generate answers to user questions and provides them in a chat format. The generation unit generates post-purchase installation images based on the answers generated by the answering unit. The generation unit, for example, uses generative AI to generate post-purchase installation images based on photos of the user's room and dimension data. Generative AI can generate installation images of purchased furniture based on photos of the user's room and dimension data. For example, the generation unit uses generative AI to generate post-purchase installation images based on photos of the user's room and dimension data. Thus, the customer service system according to the embodiment can realize high-quality customer service by shaping product description text based on user attribute information and past purchase tendencies, generating answers to user questions, and generating post-purchase installation images. Specifically, this customer service system enables each unit to collaborate under clear role assignments to provide optimized information for each user. The collection unit automatically acquires user attribute information (e.g., age=32, gender=female, interests=“Scandinavian interior”) and past purchase tendencies (e.g., purchased product ID=A123, frequency=twice a month, amount =20,000 yen) from databases or external APIs, normalizes and encodes them as numerical vectors or categorical data. The shaping unit inputs the data received from the collection unit as input tensors (e.g., attribute vector +purchase history tensor) to a natural language generation model (e.g., transformer-based large language model) and generates product description text (e.g., “This chair features Scandinavian design and is popular among 32-year-old women”). The shaping unit can select either template-based generation (e.g., replacing parts of the description for each attribute) or context generation by neural networks. The answering unit inputs the product description text output by the shaping unit and user questions (e.g., “Can this chair be folded?”) to a natural language generation model, which generates answer text (e.g., “Yes, this chair can be easily folded”) and returns it to the chat UI. The generation unit inputs the user's room image (RGB image tensor, e.g., 256×256×3) and dimension data (e.g., width 120 cm, depth 60 cm) to a conditional image generation model (e.g., diffusion model or GAN) and generates installation images compositing the planned furniture into the room image (e.g., PNG format, Base64 encoded). The output of each unit is linked as input to the next unit, enabling the system to provide personalized product descriptions, responses, and installation images to each user in real time. As a technical effect, this system enables optimized information provision for each user compared to conventional uniform explanations and manual responses, resulting in improved satisfaction, purchase motivation, repeat rate, and significant improvements in overall system processing efficiency, scalability, and data management. Application fields include virtual customer service for e-commerce sites, online consultations for furniture and electronics sales, installation simulations for home renovations, and personalized recommendations for fashion e-commerce.

The collection unit can collect user attribute information such as age, gender, and interests, as well as data of products previously purchased by the user. The collection unit collects, for example, user attribute information such as age, gender, and interests. For example, the collection unit collects information such as user age range, gender options, and interest categories. Additionally, the collection unit can collect data of products previously purchased by the user. For example, the collection unit collects data such as purchase date, product name, and purchase amount. By collecting user attribute information and past purchase data, the collection unit can shape more accurate product description text. Specifically, the collection unit automatically acquires user attribute information (e.g., age=28, gender=male, interests=“outdoor”) from web forms, membership registration information, or external databases, and encodes them as numerical vectors (e.g., age=28, gender=1, interests=3) or categorical data. Furthermore, the collection unit collects past purchase data (e.g., purchase date=2024 May 1, product name=“camp chair”, amount=8,000 yen) as time-series data and manages it as a purchase history tensor (e.g., [[2024 May 1, 1, 8000], [2024 Apr. 10, 2, 12000], . . . ]). The collection unit preprocesses these data through normalization, one-hot encoding, and time-series padding to optimize them as input data for AI models. The AI model uses these high-dimensional data as input to enable personalized product description text generation and recommendations based on user purchase tendencies and attributes. As a technical effect, detailed and diverse data collection and preprocessing by the collection unit improve the input accuracy of the AI model, resulting in significant improvements in the personalization, recommendation accuracy, and response quality of product description text. Application fields include personalized recommendations for e-commerce sites, customer analysis for retail stores, and user profiling for subscription services.

The shaping unit can shape product description text using generative AI based on the data collected by the collection unit. The shaping unit, for example, uses generative AI to shape product description text based on the data collected by the collection unit. Generative AI may utilize technologies such as natural language generation models or template-based generation. For example, the shaping unit uses generative AI to shape product description text based on user attribute information and past purchase tendencies. Generative AI analyzes user attribute information and past purchase tendencies and shapes product description text based on the analysis. Thus, by using generative AI, the shaping unit can shape product description text based on user attribute information and past purchase tendencies. Specifically, the shaping unit inputs user attribute vectors (e.g., age=35, gender=female, interests=“Scandinavian furniture”) and purchase history tensors (e.g., time-series arrays of product IDs, categories, and amounts purchased over the past six months) received from the collection unit as input tensors to generative AI. Generative AI uses transformer-based large language models (e.g., encoder-decoder architecture) or conditional natural language generation models to analyze input tensors in high-dimensional feature space and generate product description text optimized for user attributes and purchase tendencies (e.g., “This Scandinavian chair is a simple design popular among 35-year-old women”). The shaping unit can select either template-based generation (e.g., replacing parts of the description for each attribute) or context generation by neural networks (e.g., embedding attributes and history as vectors and generating context using self-attention mechanisms). Examples of AI input include attribute vectors ([35, 0, 1, . . . ]), purchase history tensors ([[A123, 2024 May 1, 12000], . . . ]), and output examples include natural language text (“This product . . . ”). As a technical effect, AI-generated description text by the shaping unit greatly improves personalization, explanation accuracy, and appeal compared to conventional template-based explanations, contributing to increased purchase motivation and satisfaction. Application fields include automatic generation of product descriptions for e-commerce sites, customized advertising text generation, and digital signage for retail stores.

The answering unit can generate answers to user questions using generative AI and provide them in a chat format. The answering unit, for example, uses generative AI to generate answers to user questions and provides them in a chat format. Generative AI can generate appropriate answers to user questions and provide them in a chat format. For example, the answering unit uses generative AI to generate answers to user questions and provides them in a chat format. Generative AI can generate appropriate answers to user questions and provide them in a chat format. Thus, by using generative AI, the answering unit can provide appropriate answers to user questions in real time. Specifically, the answering unit inputs the product description text generated by the shaping unit and user question text (e.g., “What is the power consumption of this refrigerator?”) as input data to a natural language generation model (e.g., transformer-based large language model). Examples of AI input include product description text (“This refrigerator . . . ”), question text (“What is the power consumption?”), and user attribute vectors ([28, 1, 2, . . . ]). Generative AI analyzes these inputs in high-dimensional feature space, extracts the intent of the question, and outputs appropriate answer text (e.g., “The annual power consumption of this refrigerator is 120 kWh”) as natural language text. Output examples include text (UTF-8 encoded) and answer confidence scores (0.92). The answering unit displays the generated answer text in the chat UI in real time and continues the dialogue with the user. Subsequent processing includes branching to provide additional information or prompt re-questioning if the answer confidence is below a threshold (e.g., 0.8). As a technical effect, AI-generated responses by the answering unit greatly improve diversity of question intent, context understanding, and personalization compared to conventional FAQ or rule-based responses, resulting in improved user satisfaction, response accuracy, and system automation efficiency. Application fields include chatbots for e-commerce sites, customer support automation, and FAQ automatic response.

The generation unit can generate post-purchase installation images using generative AI based on photos of the user's room and dimension data. The generation unit, for example, uses generative AI to generate post-purchase installation images based on photos of the user's room and dimension data. Generative AI can generate installation images of purchased furniture based on photos of the user's room and dimension data. For example, the generation unit uses generative AI to generate post-purchase installation images based on photos of the user's room and dimension data. Generative AI can generate installation images of purchased furniture based on photos of the user's room and dimension data. Thus, by using generative AI, the generation unit can generate post-purchase installation images based on photos of the user's room and dimension data. Specifically, the generation unit inputs the user's room image (RGB image tensor, e.g., 256×256×3) and dimension data (e.g., numerical array of width 120 cm, depth 60 cm, height 80 cm) as input data to a conditional image generation model (e.g., diffusion model or GAN). Examples of AI input include room image tensor, furniture image tensor, and dimension vector ([120, 60, 80]). Generative AI analyzes these inputs in high-dimensional feature space and generates installation images compositing the room image and furniture image naturally (e.g., PNG image with furniture placed at the correct position and scale in the room). Output examples include installation images (PNG/JPEG format, Base64 encoded) and compositing confidence scores (0.95). The generation unit passes the generated installation images to subsequent display modules or user interfaces, allowing users to visually confirm the installation image before purchase. As a technical effect, AI image generation by the generation unit greatly improves compositing accuracy, generation speed, and personalization compared to manual image editing and compositing, contributing to increased purchase motivation, satisfaction, and decision support for users. Application fields include installation simulation for furniture and electronics sales, pre-image presentation for home renovations, and virtual proposals for interior design.

The generation unit can provide installation images generated by generative AI to the user. The generation unit, for example, provides installation images generated by generative AI to the user. Generative AI can generate installation images of purchased furniture based on photos of the user's room and dimension data. For example, the generation unit uses generative AI to generate post-purchase installation images based on photos of the user's room and dimension data and provides them to the user. Generative AI can generate installation images of purchased furniture based on photos of the user's room and dimension data. Thus, by providing installation images generated by generative AI to the user, the generation unit enables the user to check the installation image of a product before purchase. Specifically, the generation unit transmits and displays installation images output by generative AI (e.g., PNG format, Base64 encoded) in real time to the user's device or web browser interface. The generation unit optimizes image resolution and display size for the user's device and performs image compression or thumbnail generation as needed. Users can enlarge, rotate, and compare installation images provided by the generation unit and check multiple patterns of installation images before purchase. The generation unit collects user feedback (e.g., “OK with this arrangement,” “Move a little to the left”) and re-inputs it to the image generation model to enable re-generation and fine-tuning of installation images. As a technical effect, immediate provision of installation images by the generation unit contributes to improved decision support, purchase experience, reduced return rates, and enhanced customization for users. Application fields include installation simulation for furniture and electronics e-commerce sites, pre-image presentation for home renovations, and virtual proposals for interior design.

The collection unit can estimate the user's emotions and adjust the timing of collecting attribute information based on the estimated emotions. The collection unit, for example, estimates the user's emotions and adjusts the timing of collecting attribute information based on the estimated emotions. For example, if the user is relaxed, the collection timing is delayed to collect detailed attribute information. If the user is stressed, the collection timing is advanced to collect only the minimum necessary attribute information. Furthermore, if the user is excited, the collection timing is adjusted to collect appropriate attribute information. Thus, by adjusting the timing of collecting attribute information based on the user's emotions, the collection unit can collect attribute information at more appropriate times. Emotion estimation is realized using, for example, emotion engines or generative AI with emotion estimation functions. Generative AI may be text generation AI (e.g., LLM) or multimodal generative AI, but is not limited to these examples. Specifically, the collection unit inputs multimodal data such as user input text (e.g., “I want to browse slowly today”), voice data (e.g., tone and speech rate), and facial images (e.g., webcam images) to an emotion estimation model (e.g., multimodal emotion classification neural network). Examples of AI input include text (“I'm looking forward to it”), voice spectrogram, and face image tensor (64×64×3). The emotion estimation model analyzes these inputs and outputs emotion labels (e.g., relaxed, stressed, excited) and emotion scores (e.g., relaxation level 0.8, stress level 0.2). The collection unit dynamically adjusts the timing of collecting attribute information (e.g., detailed information during relaxation, minimum information during stress) based on the output emotion labels and scores. Subsequent processing includes branching to re-adjust collection timing if emotions change or acquiring additional data if emotion estimation accuracy is below a threshold. As a technical effect, emotion-based collection timing control by the collection unit reduces psychological burden, lowers dropout rates, and improves information collection accuracy, greatly enhancing personalization and satisfaction compared to conventional uniform collection. Application fields include personalized customer service for e-commerce sites, online counseling, and educational support systems.

The collection unit can analyze the user's past purchase history and select an appropriate collection method. The collection unit, for example, analyzes the user's past purchase history and selects the optimal collection method. For example, the collection unit analyzes the user's past purchase tendencies and prioritizes the collection of related attribute information. Additionally, the collection unit can focus on collecting attribute information related to specific product categories based on the user's purchase history. Furthermore, the collection unit can collect detailed attribute information for products with high purchase frequency based on the user's purchase history. Thus, by analyzing the user's past purchase history, the collection unit can select the optimal collection method and efficiently collect attribute information. Specifically, the collection unit automatically acquires the user's purchase history data (e.g., product ID, purchase date, category, amount, purchase frequency as time-series database) and manages it as a time-series tensor (e.g., [[A123, 2024 May 1, furniture, 12000, 2], . . . ]). The collection unit applies high-dimensional analysis methods such as clustering algorithms (e.g., k-means or hierarchical clustering) and principal component analysis (PCA) to the purchase history tensor to extract the user's purchase tendencies in multivariate space. The collection unit calculates priority scores for attribute information collection based on the extracted purchase tendency vectors (e.g., high interest in furniture category, purchase frequency of twice a month). For example, if the purchase frequency for the furniture category is high, the collection flow is dynamically changed to prioritize the collection of furniture-related attribute information (e.g., room size, interior preferences, installation space). The collection unit scores the priority of attributes to be collected and implements branching control such as collecting only attributes exceeding a threshold (e.g., 0.7 or higher) in detail. Examples of AI input include purchase history tensor ([[A123, 2024 May 1, furniture, 12000, 2], . . . ]), category one-hot vector ([0, 1, 0, 0, . . . ]), and frequency scalar value (2.0). The AI model analyzes these inputs and outputs a priority list of attributes to be collected (e.g., furniture-related 0.85, electronics-related 0.45) and recommended collection method labels (e.g., detailed collection, simple collection). Output examples include attribute collection priority list (JSON format) and collection method labels (“detailed,” “simple,” etc.). Subsequent processing includes branching control to present additional questions or detailed input forms for high-priority attributes and omitting or simplifying input for low-priority attributes. As a technical effect, dynamic collection method selection based on purchase history by the collection unit enables optimized information collection for each user, greatly improving collection efficiency, data accuracy, and reducing user burden compared to conventional uniform attribute collection. Application fields include personalized recommendations for e-commerce sites, customer profiling for retail stores, and user attribute management for subscription services. These processes are technically significant in that they realize high-dimensional data analysis, rule-based branching, and automated collection flow control by computers, unlike simple human questionnaire collection.

The collection unit can perform filtering based on the user's current living situation and areas of interest when collecting attribute information. The collection unit, for example, performs filtering based on the user's current living situation and areas of interest when collecting attribute information. For example, the collection unit collects relevant attribute information based on the user's current living situation (e.g., family structure, occupation). Additionally, the collection unit can filter and collect attribute information based on the user's areas of interest (e.g., hobbies, interests). Furthermore, the collection unit can determine the priority of attribute information to be collected according to the user's living situation and areas of interest. Thus, by filtering attribute information based on the user's current living situation and areas of interest, the collection unit can collect more relevant information. Specifically, the collection unit encodes living situation data obtained from the user (e.g., family structure=“couple +one child,” occupation=“company employee,” residence type=“apartment”) and areas of interest data (e.g., hobby=“outdoor,” interest=“Scandinavian interior”) as categorical or numerical vectors. The collection unit inputs these vectors as input tensors (e.g., [1, 0, 2, 0, 1, . . . ]) to the AI model and calculates relevance scores for each living situation and area of interest. The AI model combines rule-based filtering (e.g., prioritizing safety-related attributes if family structure includes children) and multivariate analysis by neural networks (e.g., calculating correlation scores between areas of interest and product categories) to output a priority list of attributes to be collected (e.g., safety 0.9, design 0.7, price 0.5). Output examples include attribute priority list (JSON format) and filtered attribute list (e.g., safety, design). Subsequent processing includes branching control to present detailed input forms for high-priority attributes and omitting or simplifying input for low-priority attributes. As a technical effect, filtering attribute information based on living situation and areas of interest by the collection unit enables efficient collection of only highly relevant information for each user compared to conventional uniform information collection, greatly improving data accuracy, collection efficiency, and user experience. Application fields include personalized recommendations for e-commerce sites, customer interviews for home renovations, and customized proposals for insurance products. These processes are technically significant in that they realize high-dimensional feature extraction, rule-based branching, and automated attribute collection flow by computers, unlike simple human question list presentation.

The collection unit can estimate the user's emotions and determine the priority of attribute information to be collected based on the estimated emotions. The collection unit, for example, estimates the user's emotions and determines the priority of attribute information to be collected based on the estimated emotions. For example, if the user is relaxed, detailed attribute information is prioritized for collection. If the user is stressed, only the minimum necessary attribute information is prioritized for collection. Furthermore, if the user is excited, highly relevant attribute information is prioritized for collection. Thus, by determining the priority of attribute information to be collected based on the user's emotions, the collection unit can prioritize the collection of more appropriate information. Emotion estimation is realized using, for example, emotion engines or generative AI with emotion estimation functions. Generative AI may be text generation AI (e.g., LLM) or multimodal generative AI, but is not limited to these examples. Specifically, the collection unit inputs multimodal data such as user input text (e.g., “I want to browse slowly today”), voice data (e.g., tone and speech rate), and facial images (e.g., webcam images) to an emotion estimation model (e.g., multimodal emotion classification neural network). Examples of AI input include text (“I'm looking forward to it”), voice spectrogram, and face image tensor (64×64×3). The emotion estimation model analyzes these inputs and outputs emotion labels (e.g., relaxed, stressed, excited) and emotion scores (e.g., relaxation level 0.8, stress level 0.2). The collection unit generates a priority list of attribute information to be collected (e.g., detailed attributes 0.9, minimum attributes 0.7, relevant attributes 0.8) based on the output emotion labels and scores and controls the collection flow in order of highest priority. Subsequent processing includes recalculating the priority list and dynamically changing the collection order if emotions change, or acquiring additional data if emotion estimation accuracy is below a threshold. As a technical effect, emotion-based control of attribute collection priority by the collection unit reduces psychological burden, lowers dropout rates, and improves information collection accuracy, greatly enhancing personalization and satisfaction compared to conventional uniform collection. Application fields include personalized customer service for e-commerce sites, online counseling, and educational support systems. These processes are technically significant in that they realize multimodal emotion estimation, rule-based branching, and automated collection flow control by computers, unlike simple human control of question order.

The collection unit can preferentially collect highly relevant information based on the user's geographic location information when collecting attribute information. The collection unit, for example, considers the user's geographic location information when collecting attribute information and preferentially collects highly relevant information. For example, the collection unit prioritizes the collection of region-specific attribute information based on the user's current location. Additionally, the collection unit can analyze the user's past location information and collect highly relevant attribute information. Furthermore, the collection unit can determine the priority of attribute information to be collected based on the user's geographic location information. Thus, by considering the user's geographic location information, the collection unit can preferentially collect highly relevant information. Specifically, the collection unit manages current location information obtained from the user's device GPS data or IP address (e.g., prefecture, city, latitude and longitude) and past location history data (e.g., list of visited stores, travel routes) as time-series vectors. The collection unit inputs these location information vectors as input tensors (e.g., [35.6, 139.7, 2024 May 1, . . . ]) to the AI model and calculates relevance scores for region-specific attributes (e.g., climate, trending products, regional events). The AI model combines rule-based methods (e.g., prioritizing cold-resistance attributes for users living in Hokkaido) and geographic clustering by neural networks (e.g., calculating similarity to purchase tendencies of nearby users) to output a priority list of attributes to be collected (e.g., cold-resistance 0.9, design 0.6). Output examples include attribute priority list (JSON format) and region-specific attribute list (e.g., cold-resistance, moisture resistance). Subsequent processing includes branching control to present detailed input forms for high-priority attributes and omitting or simplifying input for low-priority attributes. As a technical effect, attribute collection based on geographic information by the collection unit greatly improves personalization, information accuracy, and user satisfaction reflecting regional characteristics compared to conventional uniform information collection. Application fields include region-specific e-commerce sites, personalized proposals for the tourism industry, and recommendations for region-limited products. These processes are technically significant in that they realize high-dimensional geographic information analysis, rule-based branching, and automated attribute collection flow by computers, unlike simple human region selection.

The collection unit can analyze the user's social media activity and collect relevant information when collecting attribute information. The collection unit, for example, analyzes the user's social media activity and collects relevant information when collecting attribute information. For example, the collection unit analyzes the content of the user's social media posts and collects relevant attribute information. Additionally, the collection unit can collect highly relevant attribute information based on the user's social media followers and friends. Furthermore, the collection unit can analyze the user's social media activity history and determine the priority of attribute information to be collected. Thus, by analyzing the user's social media activity, the collection unit can collect relevant information. Specifically, with user consent, the collection unit acquires post data (e.g., text, images, post date), follower and friend lists, and like history from social media APIs and encodes them as text vectors or graph-structured data. The collection unit uses natural language processing models (e.g., BERT-based text classification models) and graph neural networks to extract areas of interest (e.g., outdoor, gadgets) from post content and attribute tendencies (e.g., same age group, same region) from friend networks. Examples of AI input include post text vectors ([0.12, 0.34, . . . ]), friend relationship graphs, and activity frequency scalar values. The AI model analyzes these inputs and outputs a priority list of attributes to be collected (e.g., outdoor-related 0.8, gadget-related 0.7) and recommended collection method labels (e.g., detailed collection, simple collection). Output examples include attribute collection priority list (JSON format) and collection method labels (“detailed,” “simple,” etc.). Subsequent processing includes branching control to present additional questions or detailed input forms for high-priority attributes and omitting or simplifying input for low-priority attributes. As a technical effect, attribute collection based on social media activity by the collection unit greatly improves information collection accuracy, personalization, and user experience reflecting actual user interests and behavior compared to conventional self-reported information collection. Application fields include personalized recommendations for e-commerce sites, targeted advertising distribution, and attribute management for SNS-linked services. These processes are technically significant in that they realize natural language analysis, graph analysis, and automated attribute collection flow by computers, unlike simple human questionnaire collection.

The shaping unit can estimate the user's emotions and adjust the expression method of the product description text based on the estimated emotions. The shaping unit, for example, estimates the user's emotions and adjusts the expression method of the product description text based on the estimated emotions. For example, if the user is relaxed, the shaping unit uses a detailed and polite expression method. If the user is stressed, the shaping unit can use a concise and easy-to-understand expression method. Furthermore, if the user is excited, the shaping unit can use a visually attractive expression method. Thus, by adjusting the expression method of the product description text based on the user's emotions, the shaping unit can use a more appropriate expression method. Emotion estimation is realized using, for example, emotion engines or generative AI with emotion estimation functions. Generative AI may be text generation AI (e.g., LLM) or multimodal generative AI, but is not limited to these examples. Specifically, the shaping unit receives emotion estimation results (e.g., emotion labels and score values such as relaxed, stressed, excited) from the collection unit as input and uses them as control parameters for product description text generation. Emotion estimation is performed by inputting multimodal data such as user input text (e.g., “I want to browse slowly today”), voice data (e.g., tone and speech rate), and facial images (e.g., webcam images) to an emotion estimation model (e.g., multimodal emotion classification neural network), which outputs emotion labels (relaxed, stressed, excited, etc.) and emotion scores (relaxation level 0.8, stress level 0.2, etc.). The shaping unit provides these emotion information as prompts or control tokens to the product description text generation AI (e.g., transformer-based large language model), instructing, for example, “generate a detailed and polite explanation when relaxed,” “generate a concise and easy-to-understand explanation when stressed,” or “emphasize visually attractive expressions and emotional vocabulary when excited.” Examples of AI input include user attribute vectors ([32, 0, 1, . . . ]), purchase history tensor, emotion label (relaxed), emotion score (0.85), and product ID (A123). The AI model integrates these inputs and dynamically adjusts the style, vocabulary, and granularity of the product description text according to the emotional state, outputting natural language text such as “This sofa is perfect for those who want to spend a relaxing time” or “This refrigerator is energy-saving and easy to use.” Output examples include product description text (UTF-8 text), description style label (“detailed,” “concise,” “emphasis on attractiveness,” etc.), and generation confidence score (0.93). Subsequent processing includes displaying the generated description text in the chat UI or product page, collecting user reactions and feedback, and looping to re-estimate emotions and regenerate description text. As a technical effect, emotion-linked product description text generation by the shaping unit enables automatic generation of expressions optimized for the user's psychological state and situation, greatly improving comprehension, appeal, and user satisfaction compared to conventional uniform description text generation, and resulting in increased purchase motivation, site dwell time, and reduced dropout rates. Application fields include automatic generation of product descriptions for e-commerce sites, customized advertising text generation, dynamic description display for digital signage, and personalized explanation generation for online counseling and educational support systems. These processes are technically significant in that they are realized by high-dimensional emotion estimation, rule-based control, and collaboration with natural language generation models by computers, unlike simple human emotion reading or manual expression switching.

The shaping unit can adjust the level of detail of the product description text based on the importance of the product when shaping the product description text. The shaping unit, for example, adjusts the level of detail of the product description text based on the importance of the product when shaping the product description text. For example, the shaping unit shapes detailed description text for products with high importance. The shaping unit can also shape concise description text for products with low importance. Furthermore, the shaping unit can adjust the level of detail of the description text stepwise according to the importance of the product. Thus, by adjusting the level of detail of the description text based on the importance of the product, the shaping unit can shape more appropriate description text. Specifically, the shaping unit receives product information (e.g., product ID, category, sales strategy data) and product importance scores (e.g., importance labels or score values such as new product, best-selling product, clearance item) from the collection unit as input. Product importance can be automatically acquired from sales management systems or marketing databases, or calculated by AI models (e.g., sales prediction models or demand forecasting models). The shaping unit provides these importance information as prompts or control parameters to the product description text generation AI (e.g., transformer-based large language model), instructing, for example, “describe all features, advantages, use cases, and specifications in detail for high importance,” or “describe only the main points concisely for low importance.” Examples of AI input include product attribute vector ([A123, furniture, 0.95]), importance score (0.9), user attribute vector, and purchase history tensor. The AI model analyzes these inputs and dynamically adjusts the length, level of detail, and number of items described in the product description text according to the importance, outputting natural language text such as “This sofa uses high-quality materials, excels in storage functionality and durability, and can be used in various scenes such as living rooms and bedrooms” for high importance, or “This sofa is simple and easy to use” for low importance. Output examples include product description text (UTF-8 text), description detail label (“detailed,” “concise,” etc.), and generation confidence score (0.91). Subsequent processing includes displaying the generated description text in the product page or chat UI, and automatically regenerating or updating the description text if the importance changes. As a technical effect, importance-linked description text generation by the shaping unit enables automatic adjustment of the optimal amount of information and appeal for each product, greatly improving user comprehension, purchase motivation, and product appeal compared to conventional uniform description text generation, and contributing to improved inventory turnover and sales. Application fields include automatic generation of product descriptions for e-commerce sites, marketing automation, dynamic description display for digital signage, and automatic catalog generation. These processes are technically significant in that they are realized by high-dimensional data analysis, rule-based control, and collaboration with natural language generation models by computers, unlike manual adjustment of description text by humans.

The shaping unit can apply different shaping algorithms according to the product category when shaping the product description text. The shaping unit, for example, applies different shaping algorithms according to the product category when shaping the product description text. For example, the shaping unit applies visually attractive shaping algorithms to fashion items. The shaping unit can also apply shaping algorithms that emphasize functions and performance to home appliances. Furthermore, the shaping unit can apply shaping algorithms that emphasize content summaries and reviews to books. Thus, by applying different shaping algorithms according to the product category, the shaping unit can shape more appropriate description text. Specifically, the shaping unit receives product category information (e.g., category labels such as fashion, home appliances, books, food) from the collection unit as input and automatically selects different natural language generation algorithms, templates, or parameter sets for each category. For example, for the fashion category, a generation algorithm that emphasizes visual and emotional expressions (e.g., prompt design using many adjectives and color expressions) is applied; for the home appliance category, a generation algorithm that emphasizes specifications, functions, and performance comparisons (e.g., emphasizing numerical information and comparative expressions) is applied; and for the book category, an algorithm that emphasizes content summaries and review generation (e.g., using summary models and review generation models) is applied. Examples of AI input include product category label (“fashion”), product attribute vector, user attribute vector, and purchase history tensor. The AI model selects different generation pipelines or prompts for each category and outputs product description text optimized for category characteristics, such as “This dress features spring-like pastel colors and a light, comfortable feel” for fashion, “This refrigerator has high energy-saving performance and an annual power consumption of 120 kWh” for home appliances, or “This book is easy to understand for beginners and contains a wealth of practical know-how” for books. Output examples include product description text (UTF-8 text), category fit score (0.94), and generation algorithm ID. Subsequent processing includes optimizing UI display and layout for each product category and dynamically changing algorithm selection according to user reactions. As a technical effect, category-linked description text generation by the shaping unit enables automatic generation of expressions optimized for product characteristics and user needs, greatly improving appeal, comprehension, and purchase motivation compared to conventional uniform description text generation, and contributing to product differentiation and brand value enhancement. Application fields include automatic generation of product descriptions for e-commerce sites, automatic catalog generation, automatic advertising text generation, and dynamic description display for digital signage. These processes are technically significant in that they are realized by high-dimensional data analysis, rule-based control, and collaboration with natural language generation models by computers, unlike manual adjustment of description text for each category by humans.

The shaping unit can estimate the user's emotions and adjust the length of the product description text based on the estimated emotions. The shaping unit, for example, estimates the user's emotions and adjusts the length of the product description text based on the estimated emotions. For example, if the user is relaxed, the shaping unit shapes longer description text. If the user is stressed, the shaping unit can shape shorter description text. Furthermore, if the user is excited, the shaping unit can shape description text including visually attractive elements. Thus, by adjusting the length of the product description text based on the user's emotions, the shaping unit can shape description text of more appropriate length. Emotion estimation is realized using, for example, emotion engines or generative AI with emotion estimation functions. Generative AI may be text generation AI (e.g., LLM) or multimodal generative AI, but is not limited to these examples. Specifically, the shaping unit receives emotion estimation results (e.g., emotion labels and score values such as relaxed, stressed, excited) from the collection unit as input and uses them as control parameters for product description text generation AI (e.g., transformer-based large language model). Emotion estimation is performed by inputting multimodal data such as user input text, voice data, and facial images to an emotion estimation model, which outputs emotion labels and emotion scores. The shaping unit dynamically sets the maximum number of tokens, number of paragraphs, and detail parameters for the description text according to the emotion label, instructing, for example, “generate a detailed description with up to 300 tokens when relaxed,” “generate a concise description with up to 100 tokens when stressed,” or “emphasize visual and emotional expressions and generate a medium-length description when excited.” Examples of AI input include user attribute vector, purchase history tensor, emotion label (stressed), emotion score (0.7), and product ID. The AI model analyzes these inputs and dynamically adjusts the length, level of detail, and expression style of the description text according to the emotional state, outputting natural language text such as “This sofa uses high-quality materials, excels in storage functionality and durability, and can be used in various scenes such as living rooms and bedrooms” for relaxation, “This sofa is simple and easy to use” for stress, or “This sofa features vivid colors and a unique design” for excitement. Output examples include product description text (UTF-8 text), description length (number of tokens), and generation confidence score. Subsequent processing includes displaying the generated description text in the chat UI or product page, collecting user reactions and feedback, and looping to re-estimate emotions and regenerate description text. As a technical effect, emotion-linked control of description text length by the shaping unit enables automatic generation of information volume optimized for the user's psychological state and situation, greatly improving comprehension, appeal, and user satisfaction compared to conventional uniform description text generation, and resulting in increased purchase motivation, site dwell time, and reduced dropout rates. Application fields include automatic generation of product descriptions for e-commerce sites, customized advertising text generation, dynamic description display for digital signage, and personalized explanation generation for online counseling and educational support systems. These processes are technically significant in that they are realized by high-dimensional emotion estimation, rule-based control, and collaboration with natural language generation models by computers, unlike simple human emotion reading or manual length adjustment.

The shaping unit can determine the priority of the product description text based on the submission timing of the product when shaping the product description text. The shaping unit, for example, determines the priority of the product description text based on the submission timing of the product when shaping the product description text. For example, the shaping unit shapes detailed description text with priority for new products. The shaping unit can also adjust the priority of description text according to the submission timing for seasonal products. Furthermore, the shaping unit can determine the shaping order of description text based on the submission timing of the product. Thus, by determining the priority of the description text based on the submission timing of the product, the shaping unit can shape description text in a more appropriate order. Specifically, the shaping unit receives product submission timing information (e.g., new product release date, seasonal product sales period, inventory change date as timestamps or labels) from the collection unit as input and calculates priority scores based on submission timing. The shaping unit provides submission timing scores and priority labels as control parameters to the product description text generation AI (e.g., transformer-based large language model), instructing, for example, “generate detailed description text with priority for new products and seasonal products,” or “generate concise description text for existing products or products nearing end of sale.” Examples of AI input include product submission timing (2024 Jun. 1), product category, user attribute vector, and submission timing score (0.95). The AI model analyzes these inputs and dynamically adjusts the generation order, level of detail, and items described in the description text according to submission timing, outputting natural language text such as “This new sofa features the latest trends in design and is available in a limited seasonal color” for new products, or “This fan is available only in summer and features a quiet design” for seasonal products. Output examples include product description text (UTF-8 text), submission timing label (“new product,” “seasonal product,” etc.), and generation priority score. Subsequent processing includes displaying the generated description text in the product page or chat UI and automatically regenerating or updating the description text if the submission timing changes. As a technical effect, submission timing-linked description text generation by the shaping unit enables automatic adjustment of optimal timing, information volume, and appeal for each product, greatly improving user comprehension, purchase motivation, and product appeal compared to conventional uniform description text generation, and contributing to improved inventory turnover and sales. Application fields include automatic generation of product descriptions for e-commerce sites, marketing automation, dynamic description display for digital signage, and automatic catalog generation. These processes are technically significant in that they are realized by high-dimensional data analysis, rule-based control, and collaboration with natural language generation models by computers, unlike manual adjustment of description text priority by humans.

The shaping unit can adjust the order of the product description text based on the relevance of the product when shaping the product description text. The shaping unit, for example, adjusts the order of the product description text based on the relevance of the product when shaping the product description text. For example, the shaping unit shapes detailed description text with priority for highly relevant products. The shaping unit can also shape concise description text for products with low relevance. Furthermore, the shaping unit can adjust the shaping order of description text based on the relevance of the product. Thus, by adjusting the order of the product description text based on the relevance of the product, the shaping unit can shape description text in a more appropriate order. Specifically, the shaping unit receives product relevance scores (e.g., similarity to user interests and purchase history, relevance scores from recommendation engines) from the collection unit as input and determines the priority of description text generation in order of highest relevance. Product relevance is calculated by AI models (e.g., collaborative filtering or embedding-based similarity calculation models). The shaping unit provides relevance scores as control parameters to the product description text generation AI (e.g., transformer-based large language model), instructing, for example, “generate detailed description text with priority for highly relevant products,” or “generate concise description text for products with low relevance.” Examples of AI input include product ID, relevance score (0.88), user attribute vector, and purchase history tensor. The AI model analyzes these inputs and dynamically adjusts the generation order, level of detail, and items described in the description text according to relevance, outputting natural language text such as “This chair features a design optimized for your past purchase tendencies” for high relevance, or “This chair is simple and easy to use” for low relevance. Output examples include product description text (UTF-8 text), relevance label (“high,” “low,” etc.), and generation priority score. Subsequent processing includes displaying the generated description text in the product page or chat UI in order of relevance and collecting user reactions and feedback to dynamically readjust relevance scores and generation order. As a technical effect, relevance-linked description text generation by the shaping unit enables optimized information provision for user interests and needs, greatly improving appeal, comprehension, and purchase motivation compared to conventional uniform description text generation, and contributing to product differentiation and brand value enhancement. Application fields include automatic generation of product descriptions for e-commerce sites, integration with recommendation engines, automatic catalog generation, and dynamic description display for digital signage. These processes are technically significant in that they are realized by high-dimensional data analysis, rule-based control, and collaboration with natural language generation models by computers, unlike manual adjustment of description text order by humans.

The shaping unit can adjust the order of product description text based on product relevance when shaping the product description text. For example, the shaping unit adjusts the order of the description text based on product relevance during the shaping of the product description text. For instance, the shaping unit preferentially shapes detailed description text for highly relevant products. Additionally, the shaping unit can shape concise description text for products with low relevance. Furthermore, the shaping unit can also adjust the shaping order of the description text based on product relevance. By adjusting the order of the description text based on product relevance, the shaping unit can shape the description text in a more appropriate order. Specifically, the shaping unit receives a product relevance score (e.g., similarity to user interests and purchase history, relevance score from a recommendation engine, etc.) from the collection unit as input and determines the priority for generating description text in order from products with higher relevance. Product relevance is calculated by an AI model (e.g., collaborative filtering or embedding-based similarity calculation model). The shaping unit assigns the relevance score as a control parameter to the product description text generation AI (e.g., transformer-based large language model), instructing it to “generate detailed description text preferentially” for high relevance and “generate concise description text” for low relevance. Examples of AI input include product ID, relevance score (0.88), user attribute vector, purchase history tensor, etc. The AI model analyzes these inputs and dynamically adjusts the generation order, level of detail, and items described in the product description text according to relevance, outputting the product description text as natural language text (e.g., high relevance: “This chair is designed to optimize for your past purchase tendencies”/low relevance: “This chair is simple and easy to use”). Output examples include product description text (UTF-8 text), relevance label (“high”, “low”, etc.), and generation priority score. Subsequent processing may involve displaying the generated description text in order of relevance on product pages or chat UIs, and collecting user reactions and feedback to dynamically readjust the relevance score and generation order. The technical effect is that relevance-linked description text generation by the shaping unit enables information provision optimized for user interests and needs, greatly improving the appeal, comprehensibility, and purchase motivation of the description text, and contributing to product differentiation and enhancement of brand value compared to conventional uniform description text generation. Application fields include automatic generation of product descriptions for e-commerce sites, integration with recommendation engines, automatic catalog generation, and dynamic description display on digital signage. These processes are technically significant in that they are realized by computer-based high-dimensional data analysis, rule-based control, and integration with natural language generation models, unlike manual adjustment of description text order by humans.

The answering unit can estimate the user's emotions and adjust the method of expressing answers based on the estimated emotions. For example, the answering unit estimates the user's emotions and adjusts the method of expressing answers based on the estimated emotions. For instance, when the user is relaxed, the answering unit uses a detailed and polite expression method. When the user is feeling stressed, the answering unit can use a concise and easy-to-understand expression method. Furthermore, when the user is excited, the answering unit can use a visually appealing expression method. By adjusting the method of expressing answers based on the user's emotions, the answering unit can use a more appropriate expression method. Emotion estimation is realized using, for example, an emotion engine or generative AI with emotion estimation functionality. Generative AI may be a text generation AI (e.g., LLM) or a multimodal generative AI, but is not limited to these examples. Specifically, the answering unit receives the user's emotion estimation results (e.g., emotion labels such as relaxed, stressed, excited, and score values) from the collection unit as input and utilizes them as control parameters for the answer generation AI (e.g., transformer-based large language model or multimodal generation model). Emotion estimation is performed by inputting multimodal data such as user input text (e.g., “I want to browse slowly today”), voice data (e.g., tone and speech rate), and facial images (e.g., webcam images) into an emotion estimation model (e.g., multimodal emotion classification neural network), which outputs emotion labels (relaxed, stressed, excited, etc.) and emotion scores (relaxation level 0.8, stress level 0.2, etc.). The answering unit assigns these emotion information as prompts or control tokens to the answer generation AI, instructing, for example, “generate a detailed and polite explanation when relaxed,” “generate a concise and easy-to-understand explanation when stressed,” and “emphasize visually appealing expressions and emotional vocabulary when excited.” Examples of AI input include product description text (“This refrigerator...”), question text (“What is the power consumption?”), user attribute vector ([28, 1, 2, . . . ]), emotion label (relaxed), and emotion score (0.85). The AI model integrates these inputs and outputs answer text dynamically adjusted in style, vocabulary, and granularity according to the emotional state (e.g., relaxed: “This refrigerator has an annual power consumption of 120 kWh, is designed for quiet operation, and is equipped with energy-saving features, so you can use it with peace of mind”/stressed: “This refrigerator's annual power consumption is 120 kWh”/excited: “This refrigerator is equipped with the latest energy-saving technology, making everyday life more comfortable!”). Output examples include answer text (UTF-8 text), explanation style label (“detailed”, “concise”, “emphasis on appeal”, etc.), and generation confidence score (0.93). Subsequent processing may involve displaying the generated answer text in the chat UI, collecting user reactions and feedback, and performing loop control for re-estimating emotions and regenerating answer text. The technical effect is that emotion-linked answer generation by the answering unit enables automatic generation of expressions optimized for the user's psychological state and situation, greatly improving the comprehensibility, appeal, and user satisfaction of answers, and resulting in increased purchase motivation, site dwell time, and reduced churn rate compared to conventional uniform answer generation. Application fields include e-commerce site chatbots, automated customer support, FAQ automatic response, personalized answer generation for online counseling and educational support systems, etc. These processes are technically significant in that they are realized by computer-based high-dimensional emotion estimation, rule-based control, and integration with natural language generation models, unlike simple human emotion reading and manual expression switching.

The answering unit can adjust the level of detail of answers based on the importance of the question when generating answers. For example, the answering unit adjusts the level of detail of answers based on the importance of the question during answer generation. For instance, the answering unit generates detailed answers for highly important questions. Additionally, the answering unit can generate concise answers for questions with low importance. Furthermore, the answering unit can adjust the level of detail of answers stepwise according to the importance of the question. By adjusting the level of detail of answers based on the importance of the question, the answering unit can generate more appropriate answers. Specifically, the answering unit receives question information (e.g., question ID, category, user attributes, question content) and question importance scores (e.g., urgency, FAQ frequency, user interest score, etc.) from the collection unit as input. Question importance can be automatically calculated by analyzing the user's past question history, the system's FAQ database, or by AI models (e.g., question classification models or urgency estimation models). The answering unit assigns these importance information as prompts or control parameters to the answer generation AI (e.g., transformer-based large language model), instructing “describe comprehensive details, procedures, and related information for high importance” and “describe only the main points concisely for low importance.” Examples of AI input include question content (“What is the power consumption of this refrigerator?”), question importance score (0.92), user attribute vector, and product description text. The AI model analyzes these inputs and outputs answer text dynamically adjusted in length, level of detail, and number of items described according to importance (e.g., high importance: “This refrigerator has an annual power consumption of 120 kWh, is designed for quiet operation, and is equipped with energy-saving features. Furthermore, it is equipped with the latest inverter technology, contributing to electricity cost savings”/low importance: “This refrigerator's annual power consumption is 120 kWh”). Output examples include answer text (UTF-8 text), answer detail label (“detailed”, “concise”, etc.), and generation confidence score (0.91). Subsequent processing may involve displaying the generated answer text in the chat UI or FAQ page, and regenerating or automatically updating the answer text when the importance of the question changes. The technical effect is that importance-linked answer generation by the answering unit enables automatic adjustment of the optimal amount of information and appeal for each question, greatly improving user comprehension, satisfaction, and support quality, and contributing to improved inquiry response efficiency and overall system automation rate compared to conventional uniform answer generation. Application fields include e-commerce site chatbots, automated customer support, FAQ automatic response, marketing automation, etc. These processes are technically significant in that they are realized by computer-based high-dimensional data analysis, rule-based control, and integration with natural language generation models, unlike manual adjustment of answer detail level by humans.

The answering unit can apply different answer algorithms according to the category of the question when generating answers. For example, the answering unit applies different answer algorithms according to the category of the question during answer generation. For instance, the answering unit applies specialized answer algorithms for technical questions. Additionally, the answering unit can apply concise and easy-to-understand answer algorithms for general questions. Furthermore, the answering unit can apply answer algorithms that emphasize product features and advantages. By applying different answer algorithms according to the category of the question, the answering unit can generate more appropriate answers. Specifically, the answering unit receives question category information (e.g., technical, general, product features, usage, troubleshooting, etc.) from the collection unit as input and automatically selects different natural language generation algorithms, templates, or parameter sets for each category. For example, for the technical category, a generation algorithm that emphasizes technical terms and detailed procedural explanations (e.g., technical document generation model) is applied; for the general category, a generation algorithm that emphasizes plain vocabulary and concise explanations is applied; and for the product features category, an algorithm that emphasizes advantages and usage scenes (e.g., prompt design or feature extraction model) is applied. Examples of AI input include question category label (“technical”), question content, user attribute vector, and product description text. The AI model selects different generation pipelines or prompts for each category and outputs answer text optimized for category characteristics (e.g., technical: “This refrigerator uses inverter control technology to automatically adjust power consumption”/general: “This refrigerator is energy-saving and easy to use”/product features: “This refrigerator is designed for quiet operation and can be installed in a bedroom”). Output examples include answer text (UTF-8 text), category fit score (0.94), and generation algorithm ID. Subsequent processing may involve optimizing the UI display or layout of the generated answer text for each question category and dynamically changing the algorithm selection according to user reactions. The technical effect is that category-linked answer generation by the answering unit enables automatic generation of expressions optimized for question characteristics and user needs, greatly improving the appeal, comprehensibility, and user satisfaction of answers, and contributing to improved inquiry response efficiency and brand value compared to conventional uniform answer generation. Application fields include e-commerce site chatbots, FAQ automatic response, automated customer support, dynamic answer display on digital signage, etc. These processes are technically significant in that they are realized by computer-based high-dimensional data analysis, rule-based control, and integration with natural language generation models, unlike manual adjustment of answers for each category by humans.

The answering unit can estimate the user's emotions and adjust the length of answers based on the estimated emotions. For example, the answering unit estimates the user's emotions and adjusts the length of answers based on the estimated emotions. For instance, when the user is relaxed, the answering unit generates longer answers. When the user is feeling stressed, the answering unit can generate shorter answers. Furthermore, when the user is excited, the answering unit can generate answers that include visually appealing elements. By adjusting the length of answers based on the user's emotions, the answering unit can generate answers of a more appropriate length. Emotion estimation is realized using, for example, an emotion engine or generative AI with emotion estimation functionality. Generative AI may be a text generation AI (e.g., LLM) or a multimodal generative AI, but is not limited to these examples. Specifically, the answering unit receives the user's emotion estimation results (e.g., emotion labels such as relaxed, stressed, excited, and score values) from the collection unit as input and utilizes them as control parameters for the answer generation AI (e.g., transformer-based large language model or multimodal generation model). Emotion estimation is performed by inputting multimodal data such as user input text, voice data, and facial images into an emotion estimation model, which outputs emotion labels and emotion scores. The answering unit dynamically sets the maximum token count, number of paragraphs, and detail parameters of the answer text according to the emotion label, instructing, for example, “generate a detailed answer with up to 300 tokens when relaxed,” “generate a concise answer with up to 100 tokens when stressed,” and “generate a medium-length answer emphasizing visual and emotional expressions when excited.” Examples of AI input include question content, user attribute vector, emotion label (stressed), emotion score (0.7), and product description text. The AI model analyzes these inputs and outputs answer text dynamically adjusted in length, level of detail, and expression style according to the emotional state (e.g., relaxed: “This refrigerator has an annual power consumption of 120 kWh, is designed for quiet operation, and is equipped with energy-saving features. Furthermore, it is equipped with the latest inverter technology, contributing to electricity cost savings”/stressed: “This refrigerator's annual power consumption is 120 kWh”/excited: “This refrigerator features vibrant colors and the latest technology!”). Output examples include answer text (UTF-8 text), answer text length (token count), and generation confidence score. Subsequent processing may involve displaying the generated answer text in the chat UI or FAQ page, collecting user reactions and feedback, and performing loop control for re-estimating emotions and regenerating answer text. The technical effect is that emotion-linked answer length control by the answering unit enables automatic generation of information volume optimized for the user's psychological state and situation, greatly improving the comprehensibility, appeal, and user satisfaction of answers, and resulting in increased purchase motivation, site dwell time, and reduced churn rate compared to conventional uniform answer generation. Application fields include e-commerce site chatbots, automated customer support, FAQ automatic response, personalized answer generation for online counseling and educational support systems, etc. These processes are technically significant in that they are realized by computer-based high-dimensional emotion estimation, rule-based control, and integration with natural language generation models, unlike simple human emotion reading and manual length adjustment.

The answering unit can determine the priority of answers based on the submission timing of questions when generating answers. For example, the answering unit determines the priority of answers based on the submission timing of questions during answer generation. For instance, the answering unit generates detailed answers preferentially for urgent questions. Additionally, the answering unit can generate concise answers for older questions. Furthermore, the answering unit can determine the priority of answers based on the submission timing of questions. By determining the priority of answers based on the submission timing of questions, the answering unit can generate answers in a more appropriate order. Specifically, the answering unit receives question submission timing information (e.g., question reception date and time, urgency label, user attributes, question content) from the collection unit as input and calculates a priority score based on submission timing and urgency. Submission timing and urgency can be automatically calculated by analyzing the user's past question history, the system's inquiry management database, or by AI models (e.g., urgency estimation models or time-series priority models). The answering unit assigns these priority information as control parameters to the answer generation AI (e.g., transformer-based large language model), instructing “generate detailed answers preferentially for urgent cases” and “generate concise answers for older submissions.” Examples of AI input include question content, question submission timing (2024 Jun. 1), urgency score (0.95), user attribute vector, and product description text. The AI model analyzes these inputs and outputs answer text dynamically adjusted in generation order, level of detail, and items described according to submission timing and urgency (e.g., urgent: “If this refrigerator malfunctions, unplug the power and restart. Detailed procedures are . . . ”/old: “This refrigerator's annual power consumption is 120 kWh”). Output examples include answer text (UTF-8 text), submission timing label (“new”, “old”, “urgent”, etc.), and generation priority score. Subsequent processing may involve displaying the generated answer text in the chat UI or FAQ page in order of submission timing and urgency, and automatically regenerating or updating the answer text when submission timing or urgency changes. The technical effect is that submission timing-linked answer generation by the answering unit enables automatic adjustment of the optimal timing, information volume, and appeal for each question, greatly improving user comprehension, satisfaction, and inquiry response efficiency, and contributing to improved system automation rate and support quality compared to conventional uniform answer generation. Application fields include e-commerce site chatbots, automated customer support, FAQ automatic response, inquiry management systems, etc. These processes are technically significant in that they are realized by computer-based high-dimensional data analysis, rule-based control, and integration with natural language generation models, unlike manual adjustment of answer priority by humans.

The answering unit can adjust the order of answers based on the relevance of questions when generating answers. For example, the answering unit adjusts the order of answers based on the relevance of questions during answer generation. For instance, the answering unit generates detailed answers preferentially for highly relevant questions. Additionally, the answering unit can generate concise answers for questions with low relevance. Furthermore, the answering unit can adjust the order of answers based on the relevance of questions. By adjusting the order of answers based on the relevance of questions, the answering unit can generate answers in a more appropriate order. Specifically, the answering unit receives question relevance scores (e.g., similarity to user interests and purchase history, relevance score from a recommendation engine, etc.) from the collection unit as input and determines the priority for generating answers in order from questions with higher relevance. Question relevance is calculated by an AI model (e.g., collaborative filtering or embedding-based similarity calculation model). The answering unit assigns the relevance score as a control parameter to the answer generation AI (e.g., transformer-based large language model), instructing it to “generate detailed answers preferentially” for high relevance and “generate concise answers” for low relevance. Examples of AI input include question ID, relevance score (0.88), user attribute vector, purchase history tensor, product description text, etc. The AI model analyzes these inputs and dynamically adjusts the generation order, level of detail, and items described in the answer text according to relevance, outputting the answer text as natural language text (e.g., high relevance: “This chair is designed to optimize for your past purchase tendencies”/low relevance: “This chair is simple and easy to use”). Output examples include answer text (UTF-8 text), relevance label (“high”, “low”, etc.), and generation priority score. Subsequent processing may involve displaying the generated answer text in order of relevance on the chat UI or FAQ page, and collecting user reactions and feedback to dynamically readjust the relevance score and generation order. The technical effect is that relevance-linked answer generation by the answering unit enables information provision optimized for user interests and needs, greatly improving the appeal, comprehensibility, and user satisfaction of answers, and contributing to improved inquiry response efficiency and brand value compared to conventional uniform answer generation. Application fields include e-commerce site chatbots, integration with recommendation engines, FAQ automatic response, automated customer support, etc. These processes are technically significant in that they are realized by computer-based high-dimensional data analysis, rule-based control, and integration with natural language generation models, unlike manual adjustment of answer order by humans.

The generation unit can estimate the user's emotions and adjust the method of generating installation images based on the estimated emotions. For example, the generation unit estimates the user's emotions and adjusts the method of generating installation images based on the estimated emotions. For instance, when the user is relaxed, the generation unit generates installation images that progress at a leisurely pace. When the user is in a hurry, the generation unit can generate installation images that emphasize the shortest route. Furthermore, when the user is excited, the generation unit can generate installation images with visually stimulating effects. By adjusting the method of generating installation images based on the user's emotions, the generation unit can generate more appropriate installation images. Emotion estimation is realized using, for example, an emotion engine or generative AI with emotion estimation functionality. Generative AI may be a text generation AI (e.g., LLM) or a multimodal generative AI, but is not limited to these examples. Specifically, the generation unit receives the user's emotion estimation results (e.g., emotion labels such as relaxed, stressed, excited, and score values) from the collection unit as input and utilizes them as control parameters for the installation image generation AI (e.g., conditional diffusion model or GAN-based image generation neural network). Emotion estimation is performed by inputting multimodal data such as user input text (e.g., “I want to browse slowly today”), voice data (e.g., tone and speech rate), and facial images (e.g., webcam images) into an emotion estimation model (e.g., multimodal emotion classification neural network), which outputs emotion labels (relaxed, stressed, excited, etc.) and emotion scores (relaxation level 0.8, stress level 0.2, etc.). The generation unit assigns these emotion information as prompts or control tokens to the image generation AI, instructing, for example, “generate with calm tones and spacious furniture layout when relaxed,” “generate with layout emphasizing furniture flow and shortest route when in a hurry,” and “generate visually impactful images with vibrant colors and dynamic effects when excited.” Examples of AI input include room image tensor (256×256×3), furniture image tensor, dimension vector ([120, 60, 80]), emotion label (excited), and emotion score (0.9). The AI model integrates these inputs and dynamically adjusts the color tone, composition, effects, and arrangement patterns of the image according to the emotional state, outputting installation images (e.g., relaxed: “image with soft tones and wide furniture spacing”/hurried: “image with flow emphasized by arrows”/excited: “image with colorful effects and animation-like style”) in PNG or JPEG format. Output examples include installation image (Base64 encoded), generation style label (“relaxed”, “hurried”, “excited”, etc.), and generation confidence score (0.94). Subsequent processing may involve displaying the generated image in real time on the user interface, collecting user reactions and feedback (e.g., “make it more calming,” “emphasize the flow”), and performing loop control for re-estimating emotions and regenerating images. The technical effect is that emotion-linked installation image generation by the generation unit enables automatic generation of visual information optimized for the user's psychological state and situation, greatly improving the comprehensibility, appeal, and user satisfaction of installation images, and resulting in increased purchase motivation, decision support, site dwell time, and reduced churn rate compared to conventional uniform image generation. Application fields include installation simulation for furniture and home appliance e-commerce sites, pre-image presentation for home renovation, virtual proposals for interior design, and emotion-linked teaching material presentation for educational support systems. These processes are technically significant in that they are realized by computer-based high-dimensional emotion estimation, rule-based control, and integration with image generation models, unlike simple human emotion reading and manual image editing.

The generation unit can analyze the user's past installation history when generating installation images and select the optimal generation method. For example, the generation unit analyzes the user's past installation history when generating installation images and selects the optimal generation method. For instance, the generation unit generates installation images based on the arrangement of products previously installed by the user. Additionally, the generation unit can generate highly relevant installation images based on the user's past installation history. Furthermore, the generation unit can analyze the user's past installation history and generate the most efficient installation images. By analyzing the user's past installation history, the generation unit can generate optimal installation images. Specifically, the generation unit manages the user's installation history data received from the collection unit (e.g., metadata of previously generated and adopted installation images, furniture arrangement patterns, installation dates, user evaluation scores, etc.) as time-series tensors or categorical vectors. The generation unit inputs these installation history tensors into clustering algorithms (e.g., k-means or self-organizing maps) or similarity calculation models (e.g., cosine similarity, Euclidean distance) to calculate similarity scores between past installation patterns and new installation candidates. The generation unit refers to past patterns with high similarity scores, extracts optimal furniture arrangements and layout patterns, and provides them as prompts to the image generation AI (e.g., conditional diffusion model or GAN). Examples of AI input include room image tensor, furniture image tensor, installation history tensor ([[furniture ID, arrangement coordinates, installation date, evaluation score], . . . ]), and similarity score (0.85). The AI model analyzes these inputs and generates installation images optimized based on past installation history and user preferences (e.g., images reproducing arrangements with high past evaluation, images emphasizing efficient flow lines). Output examples include installation image (PNG/JPEG format, Base64 encoded), adopted pattern ID, and generation confidence score. Subsequent processing may involve presenting the generated image to the user, providing a UI for comparing and selecting with past installation history, and collecting feedback to update the history database. The technical effect is that installation history-based image generation by the generation unit enables automatic generation of installation images reflecting layouts, flow lines, and preferences optimized for each user, greatly improving user satisfaction, decision support, and installation efficiency, and contributing to increased repeat rate and site dwell time compared to conventional uniform image generation. Application fields include installation simulation for furniture and home appliance e-commerce sites, history-linked proposals for home renovation, and personalized proposals for interior design. These processes are technically significant in that they are realized by computer-based high-dimensional history analysis, rule-based optimization, and integration with image generation models, unlike human memory and manual history reference.

The generation unit can customize the means of generation based on the user's current living situation when generating installation images. For example, the generation unit customizes the means of generation based on the user's current living situation when generating installation images. For instance, when the user lives with family, the generation unit generates installation images in which all family members can spend time comfortably. Additionally, when the user lives alone, the generation unit can generate installation images tailored to the individual's lifestyle. Furthermore, when the user has pets, the generation unit can generate installation images that consider pet safety. By customizing the means of generation based on the user's current living situation, the generation unit can generate more appropriate installation images. Specifically, the generation unit encodes living situation data received from the collection unit (e.g., family composition=“couple+one child”, residence type=“apartment”, pet presence=“dog”, etc.) as categorical or numerical vectors and provides them as control parameters to the image generation AI (e.g., conditional diffusion model or GAN). The generation unit automatically selects different generation algorithms or prompts for each living situation, such as “widen furniture spacing and consider children's flow lines and safety for family living together,” “emphasize space-saving and individual hobbies/work flow for living alone,” and “emphasize pet passageways and hazard avoidance zones for pet owners.” Examples of AI input include room image tensor, furniture image tensor, living situation vector ([family 3, pet 1, apartment 1]), and user attribute vector. The AI model analyzes these inputs and generates installation images optimized for the living situation (e.g., family living together: “image emphasizing wide flow lines and safety fences”/living alone: “image emphasizing desk and hobby space”/pet owners: “image emphasizing pet space and anti-slip mats”). Output examples include installation image (PNG/JPEG format, Base64 encoded), living situation label, and generation confidence score. Subsequent processing may involve presenting the generated image to the user, and performing loop control for regeneration according to changes in living situation or additional requests (e.g., “expand pet space”). The technical effect is that living situation-linked image generation by the generation unit enables automatic generation of installation images optimized for the user's actual living environment and needs, greatly improving user satisfaction, purchase motivation, and post-installation satisfaction, and contributing to enhanced customization and proposal capabilities compared to conventional uniform image generation. Application fields include installation simulation for furniture and home appliance e-commerce sites, living situation-linked proposals for home renovation, and virtual design support for pet-friendly housing. These processes are technically significant in that they are realized by computer-based high-dimensional living situation analysis, rule-based control, and integration with image generation models, unlike human hearing and manual layout adjustment.

The generation unit can estimate the user's emotions and determine the priority of installation images based on the estimated emotions. For example, the generation unit estimates the user's emotions and determines the priority of installation images based on the estimated emotions. For instance, when the user is relaxed, the generation unit preferentially generates detailed installation images. When the user is feeling stressed, the generation unit can preferentially generate concise installation images. Furthermore, when the user is excited, the generation unit can preferentially generate visually appealing installation images. By determining the priority of installation images based on the user's emotions, the generation unit can generate installation images in a more appropriate order. Emotion estimation is realized using, for example, an emotion engine or generative AI with emotion estimation functionality. Generative AI may be a text generation AI (e.g., LLM) or a multimodal generative AI, but is not limited to these examples. Specifically, the generation unit receives the user's emotion estimation results (e.g., emotion labels such as relaxed, stressed, excited, and score values) from the collection unit as input and utilizes them as control parameters for the installation image generation AI (e.g., conditional diffusion model or GAN). The generation unit generates a priority list for images to be generated according to the emotion label (e.g., detailed image 0.9, concise image 0.7, appeal-emphasized image 0.8) and controls the generation flow in order from images with higher priority. Examples of AI input include room image tensor, furniture image tensor, emotion label (relaxed), emotion score (0.85), and generation candidate list. The AI model analyzes these inputs and dynamically adjusts the level of detail, expression style, and generation order of the generated images according to the emotional state, outputting installation images (e.g., relaxed: “image emphasizing detailed furniture arrangement and color tone”/stressed: “image expressing only the main points concisely”/excited: “image with vibrant colors and dynamic effects”) in PNG or JPEG format. Output examples include installation image (PNG/JPEG format, Base64 encoded), generation priority label, and generation confidence score. Subsequent processing may involve presenting the generated images to the user in order of priority, and collecting user reactions and feedback to dynamically readjust the priority list and generation order. The technical effect is that emotion-linked image generation priority control by the generation unit enables information presentation optimized for the user's psychological state and situation, greatly improving the comprehensibility, appeal, and user satisfaction of installation images, and resulting in increased purchase motivation, decision support, site dwell time, and reduced churn rate compared to conventional uniform image generation. Application fields include installation simulation for furniture and home appliance e-commerce sites, pre-image presentation for home renovation, virtual proposals for interior design, and emotion-linked teaching material presentation for educational support systems. These processes are technically significant in that they are realized by computer-based high-dimensional emotion estimation, rule-based control, and integration with image generation models, unlike simple human emotion reading and manual adjustment of image presentation order.

The generation unit can select the optimal generation method by considering the user's geographic location information when generating installation images. For example, the generation unit selects the optimal generation method by considering the user's geographic location information when generating installation images. For instance, the generation unit generates region-specific installation images based on the user's current location. Additionally, the generation unit can analyze the user's past location information and generate highly relevant installation images. Furthermore, the generation unit can customize the method of generating installation images based on the user's geographic location information. By considering the user's geographic location information, the generation unit can generate optimal installation images. Specifically, the generation unit manages the user's current location information received from the collection unit (e.g., prefecture, city, latitude and longitude) and past location history data (e.g., list of visited stores, movement routes) as time-series or categorical vectors and provides them as control parameters to the image generation AI (e.g., conditional diffusion model or GAN). To generate installation images reflecting region-specific climate, trends, architectural styles, and living habits, the generation unit automatically selects different generation algorithms or prompts for each geographic information, such as “emphasize cold protection and insulation in furniture arrangement for Hokkaido residents,” “emphasize ventilation and moisture resistance in layout for Okinawa residents,” etc. Examples of AI input include room image tensor, furniture image tensor, geographic information vector ([35.6, 139.7, 2024 May 1]), and region-specific label. The AI model analyzes these inputs and generates installation images optimized for geographic location information (e.g., cold region: “image emphasizing thick curtains and insulation mats”/warm region: “image with well-ventilated furniture arrangement and bright color tones”). Output examples include installation image (PNG/JPEG format, Base64 encoded), region-specific label, and generation confidence score. Subsequent processing may involve presenting the generated image to the user and performing loop control for regeneration according to changes in region-specific characteristics or additional requests. The technical effect is that geographic information-linked image generation by the generation unit enables automatic generation of installation images optimized for region-specific characteristics and living environments, greatly improving user satisfaction, purchase motivation, and post-installation satisfaction, and contributing to enhanced appeal of region-limited products and brand value compared to conventional uniform image generation. Application fields include region-specific e-commerce site installation simulation, region-linked proposals for tourism, and region-specific design support for home renovation. These processes are technically significant in that they are realized by computer-based high-dimensional geographic information analysis, rule-based control, and integration with image generation models, unlike simple human region selection and manual image editing.

The generation unit can analyze the user's social media activity when generating installation images and propose means of generation. For example, the generation unit analyzes the user's social media activity when generating installation images and proposes means of generation. For instance, the generation unit analyzes the user's social media posts and generates relevant installation images. Additionally, the generation unit can generate highly relevant installation images based on the user's social media followers and friends information. Furthermore, the generation unit can analyze the user's social media activity history and propose means of generating installation images. By analyzing the user's social media activity, the generation unit can propose more appropriate means of generating installation images. Specifically, the generation unit encodes the user's social media data received from the collection unit (e.g., post text, images, post date, follower/friend list, like history, etc.) as text vectors or graph structure data and uses natural language processing models (e.g., BERT-based text classification model) or graph neural networks to extract the user's areas of interest (e.g., Scandinavian interior, outdoor, minimalism, etc.) and friend network trends (e.g., trends among peers or in the same region). The generation unit provides the extracted areas of interest and network trends as prompts or control parameters to the image generation AI (e.g., conditional diffusion model or GAN), automatically proposing means of generation based on social media activity, such as “if Scandinavian interior is an area of interest, generate with bright wood tones and simple furniture arrangement,” “if outdoor-oriented, generate with layouts emphasizing green and natural materials,” etc. Examples of AI input include room image tensor, furniture image tensor, interest area vector, friend relationship graph, and activity frequency scalar value. The AI model analyzes these inputs and outputs installation images optimized for social media activity (e.g., images reflecting styles liked by many friends, images emphasizing trendy colors and popular layouts) and means of generation labels (“Scandinavian”, “Outdoor”, “Minimal”, etc.). Output examples include installation image (PNG/JPEG format, Base64 encoded), means of generation label, and generation confidence score. Subsequent processing may involve presenting the generated images and proposed means to the user, providing a UI for selection and customization, and collecting feedback to optimize the means of generation. The technical effect is that social media activity-linked proposal of means of image generation by the generation unit enables high-precision installation image generation and personalization reflecting the user's actual interests, behavior, and trends, greatly improving user experience compared to conventional self-reported or uniform image generation. Application fields include personalized installation simulation for e-commerce sites, virtual proposals for SNS-linked services, and targeting for ad distribution. These processes are technically significant in that they are realized by computer-based natural language analysis, graph analysis, and automated image generation flow, unlike simple human survey collection and manual image generation.

The system according to the embodiment is not limited to the examples described above and can be variously modified as follows, for example. Specifically, the present system allows for various technical variations such as AI model architecture, data flow, input/output specifications, control algorithms, user interface, database integration, external API integration, security control, and addition of extension modules. For example, AI models may be used in combination, including transformer-based large language models, conditional diffusion models, GANs, VAEs, graph neural networks, time-series prediction models, anomaly detection models, etc. As for data flow, it is possible to integrate diverse data sources such as user attributes, purchase history, emotions, location information, social media activity, and living situation, and perform integrated analysis and generation by multimodal AI. Input/output specifications may support various data types such as text, images, audio, video, structured data, scores, labels, and JSON format, and modules may be linked via APIs or message queues. Control algorithms may include rule-based branching, reinforcement learning, Bayesian optimization, evolutionary algorithms, and user feedback loops to achieve autonomous optimization and improved personalization for the entire system. User interfaces may support various channels such as web browsers, smartphone apps, voice dialogue UIs, and AR/VR interfaces. Database integration may select RDB, NoSQL, time-series DB, graph DB, etc. according to the application, and external API integration may include SNS, IoT devices, external product DBs, payment systems, etc. Security control may implement authentication/authorization, encryption, access control, audit logs, privacy protection functions, etc. Extension modules may include anomaly detection, recommendation engines, image editing, speech synthesis, translation, summarization, explanation generation, emotion analysis, user profiling, etc. The technical effect is that the present system, by allowing these diverse technical variations, can greatly improve system scalability, flexibility, application range, operational efficiency, security, personalization, and user experience. Application fields include e-commerce sites, retail stores, home renovation, fashion, education, healthcare, tourism, advertising, SNS-linked services, IoT-linked services, and can be deployed in a wide range of industries and business types. These technical improvements are not merely automation of human tasks, but realize high-dimensional data integration, multimodal inference, autonomous optimization, and highly extensible system design by computers, which is the significance of the present invention.

The collection unit can predict new products that the user is likely to be interested in based on the user's purchase history and provide them to the shaping unit. For example, the collection unit analyzes the user's past purchase tendencies and predicts related new products. Additionally, the collection unit can preferentially collect information on new products based on the user's interests. Furthermore, the collection unit can predict new products in specific categories based on the user's purchase history and provide them to the shaping unit. By predicting new products based on the user's purchase history and providing them to the shaping unit, the collection unit enables the shaping of product description text that is attractive to the user. Specifically, the collection unit automatically acquires the user's purchase history data (e.g., time-series database including product ID, purchase date, category, amount, purchase frequency, etc.) and manages these as time-series tensors or categorical vectors. The collection unit applies high-dimensional analysis methods such as clustering algorithms (e.g., k-means or hierarchical clustering), principal component analysis (PCA), collaborative filtering, and embedding-based similarity calculation models to the purchase history tensor to extract the user's purchase tendencies and interests in a multivariate space. Based on the extracted tendency vectors and category scores, the collection unit generates a new product candidate list and provides it to the shaping unit. Examples of AI input include purchase history tensor, category one-hot vector, frequency scalar value, and user attribute vector. The AI model analyzes these inputs and outputs new product candidates that the user is likely to be interested in (e.g., list of new furniture category product IDs with relevance scores). Output examples include new product candidate list (JSON format), relevance score, and prediction confidence score. Subsequent processing may involve the shaping unit receiving the new product candidate list and using it for product description text generation or recommendation display. The technical effect is that purchase history-based new product prediction by the collection unit enables highly optimized new product proposals, personalization, recommendation accuracy, and user experience for each user, greatly improving these aspects compared to conventional uniform product proposals. Application fields include new product recommendation for e-commerce sites, customer analysis for retail stores, and new product proposals for subscription services. These processes are technically significant in that they are realized by computer-based high-dimensional data analysis, rule-based branching, and automated new product prediction flow, unlike simple human surveys and manual product proposals.

The shaping unit can predict new products that the user is likely to be interested in based on the user's purchase history and shape description text for those new products. For example, the shaping unit analyzes the user's past purchase tendencies and shapes description text for related new products. Additionally, the shaping unit can preferentially shape description text for new products based on the user's interests. Furthermore, the shaping unit can shape description text for new products in specific categories based on the user's purchase history. By shaping description text for new products based on the user's purchase history, the shaping unit can provide product description text that is attractive to the user. Specifically, the shaping unit provides the new product candidate list received from the collection unit (e.g., list of new furniture category product IDs with relevance scores), user purchase history tensor, and user attribute vector as input tensors to a natural language generation model (e.g., transformer-based large language model). The shaping unit embeds the user's past purchase tendencies and interests as vectors, generates context with self-attention mechanisms, and generates product description text optimized for each new product (e.g., “This new chair pairs well with the Scandinavian furniture you previously purchased and is ideal for your living room”). Examples of AI input include new product ID, category label, user attribute vector, purchase history tensor, and relevance score. The AI model analyzes these inputs and outputs product description text optimized for the user's interests and purchase tendencies (e.g., “This new product is especially recommended based on your past purchase tendencies”). Output examples include product description text (UTF-8 text), description style label, and generation confidence score. Subsequent processing may involve displaying the generated description text on product pages or chat UIs, collecting user reactions and feedback, and performing loop control for regenerating description text. The technical effect is that purchase history-linked new product description text generation by the shaping unit enables highly optimized personalization, description accuracy, and appeal for each user, greatly improving these aspects compared to conventional uniform description text generation and contributing to increased purchase motivation and satisfaction. Application fields include automatic generation of new product descriptions for e-commerce sites, customized ad text generation, and digital signage for retail stores. These processes are technically significant in that they are realized by computer-based high-dimensional data analysis, rule-based control, and integration with natural language generation models, unlike manual description text creation by humans.

The answering unit can generate answers to questions about new products that the user is likely to be interested in based on the user's purchase history. For example, the answering unit analyzes the user's past purchase tendencies and generates answers to questions about related new products. Additionally, the answering unit can preferentially generate answers to questions about new products based on the user's interests. Furthermore, the answering unit can generate answers to questions about new products in specific categories based on the user's purchase history. By generating answers to questions about new products based on the user's purchase history, the answering unit can provide answers that are attractive to the user. Specifically, the answering unit provides the new product candidate list received from the collection unit, user purchase history tensor, user attribute vector, and user question text (e.g., “Can this new chair be folded?”) as input tensors to a natural language generation model (e.g., transformer-based large language model). Examples of AI input include new product ID, category label, user attribute vector, purchase history tensor, question text, and relevance score. The AI model analyzes these inputs and outputs answer text about new products optimized for the user's interests and purchase tendencies (e.g., “This new product can be folded just like the chair you previously purchased”). Output examples include answer text (UTF-8 text), answer style label, and generation confidence score. Subsequent processing may involve displaying the generated answer text in the chat UI or FAQ page, collecting user reactions and feedback, and performing loop control for regenerating answer text. The technical effect is that purchase history-linked new product answer generation by the answering unit enables highly optimized personalization, answer accuracy, and appeal for each user, greatly improving these aspects compared to conventional uniform answer generation and contributing to increased user satisfaction and inquiry response efficiency. Application fields include new product chatbots for e-commerce sites, automated customer support, and FAQ automatic response. These processes are technically significant in that they are realized by computer-based high-dimensional data analysis, rule-based control, and integration with natural language generation models, unlike manual answer creation by humans.

The generation unit can generate installation images of new products that the user is likely to be interested in based on the user's purchase history. For example, the generation unit analyzes the user's past purchase tendencies and generates installation images of related new products. Additionally, the generation unit can preferentially generate installation images of new products based on the user's interests. Furthermore, the generation unit can generate installation images of new products in specific categories based on the user's purchase history. By generating installation images of new products based on the user's purchase history, the generation unit can provide installation images that are attractive to the user. Specifically, the generation unit provides the new product candidate list received from the collection unit, user purchase history tensor, user attribute vector, room image tensor, and furniture image tensor as input tensors to the image generation AI (e.g., conditional diffusion model or GAN). The generation unit automatically extracts layouts, color tones, and arrangement patterns reflecting the user's past installation history and preferences, and generates installation images optimized for each new product (e.g., images reproducing arrangements with high past evaluation for new product installation, images styled according to the user's areas of interest). Examples of AI input include new product ID, category label, user attribute vector, purchase history tensor, room image tensor, furniture image tensor, and relevance score. The AI model analyzes these inputs and generates installation images of new products optimized for the user's interests and purchase tendencies. Output examples include installation image (PNG/JPEG format, Base64 encoded), generation style label, and generation confidence score. Subsequent processing may involve presenting the generated image to the user, collecting user reactions and feedback, and performing loop control for regenerating images. The technical effect is that purchase history-linked new product installation image generation by the generation unit enables highly optimized personalization, image accuracy, and appeal for each user, greatly improving these aspects compared to conventional uniform image generation and resulting in increased purchase motivation, decision support, site dwell time, and reduced churn rate. Application fields include new product installation simulation for furniture and home appliance e-commerce sites, new product proposals for home renovation, and personalized proposals for interior design. These processes are technically significant in that they are realized by computer-based high-dimensional data analysis, rule-based control, and integration with image generation models, unlike manual image creation by humans.

The collection unit can estimate the user's emotions and, based on the estimated emotions, predict new products that the user is likely to be interested in and provide them to the shaping unit. For example, when the user is relaxed, the collection unit collects detailed information on new products. When the user is feeling stressed, the collection unit can collect concise information on new products. Furthermore, when the user is excited, the collection unit can collect visually appealing information on new products. By predicting new products based on the user's emotions and providing them to the shaping unit, the collection unit enables the shaping of product description text that is attractive to the user. Specifically, the collection unit receives the user's emotion estimation results (e.g., emotion labels such as relaxed, stressed, excited, and score values) from an emotion estimation model (e.g., multimodal emotion classification neural network) and utilizes them as control parameters for the new product prediction AI (e.g., collaborative filtering or embedding-based recommendation model). According to the emotion label, the collection unit dynamically adjusts the granularity and priority of new product information collection, prioritizing “detailed new product information including specifications and usage scenes” when relaxed, “concise new product information summarizing only the main points” when stressed, and “visually appealing images and emotional descriptions” when excited. Examples of AI input include purchase history tensor, category one-hot vector, emotion label, emotion score, and user attribute vector. The AI model analyzes these inputs and outputs new product candidate lists optimized for the emotional state (e.g., with detailed information, concise information, or appeal-emphasized information). Output examples include new product candidate list (JSON format), information granularity label, and prediction confidence score. Subsequent processing may involve the shaping unit receiving the new product candidate list and using it for product description text generation. The technical effect is that emotion-linked new product prediction and information collection by the collection unit enables highly optimized new product proposals, personalization, recommendation accuracy, and user experience for each user, greatly improving these aspects compared to conventional uniform product proposals. Application fields include new product recommendation for e-commerce sites, customer analysis for retail stores, and new product proposals for subscription services. These processes are technically significant in that they are realized by computer-based high-dimensional emotion estimation, rule-based branching, and automated new product prediction flow, unlike simple human surveys and manual product proposals.

The shaping unit can estimate the user's emotions and, based on the estimated emotions, shape description text for new products that the user is likely to be interested in. For example, when the user is relaxed, the shaping unit shapes detailed description text for new products. When the user is feeling stressed, the shaping unit can shape concise description text for new products. Furthermore, when the user is excited, the shaping unit can shape visually appealing description text for new products. By shaping description text for new products based on the user's emotions, the shaping unit can provide product description text that is attractive to the user. Specifically, the shaping unit provides the new product candidate list received from the collection unit, user's emotion estimation results (emotion label and score), user attribute vector, and purchase history tensor as input tensors to a natural language generation model (e.g., transformer-based large language model). The shaping unit dynamically sets prompts and control tokens for the generative AI according to the emotion label, instructing “generate detailed and polite description text when relaxed,” “generate concise and easy-to-understand description text when stressed,” and “generate description text emphasizing visually appealing expressions and emotional vocabulary when excited.” Examples of AI input include new product ID, category label, user attribute vector, purchase history tensor, emotion label, and emotion score. The AI model analyzes these inputs and outputs new product description text optimized for the emotional state (e.g., relaxed: “This new product uses high-quality materials and is designed with attention to detail”/stressed: “This new product is easy to use”/excited: “This new product features vibrant colors and a unique design”). Output examples include product description text (UTF-8 text), description style label, and generation confidence score. Subsequent processing may involve displaying the generated description text on product pages or chat UIs, collecting user reactions and feedback, and performing loop control for regenerating description text. The technical effect is that emotion-linked new product description text generation by the shaping unit enables automatic generation of expressions optimized for the user's psychological state and situation, greatly improving the comprehensibility, appeal, and user satisfaction of description text, and resulting in increased purchase motivation, site dwell time, and reduced churn rate compared to conventional uniform description text generation. Application fields include automatic generation of new product descriptions for e-commerce sites, customized ad text generation, dynamic description display on digital signage, and personalized description generation for online counseling and educational support systems. These processes are technically significant in that they are realized by computer-based high-dimensional emotion estimation, rule-based control, and integration with natural language generation models, unlike simple human emotion reading and manual expression switching.

The answering unit is capable of estimating the user's emotions and generating answers to questions about new products that the user may be interested in, based on the estimated emotions. For example, when the user is relaxed, the answering unit generates detailed answers to questions about new products. When the user is feeling stressed, the answering unit can generate concise answers to questions about new products. Furthermore, when the user is excited, the answering unit can generate answers to questions about new products that are visually appealing. In this way, by generating answers to questions about new products based on the user's emotions, the answering unit can provide answers that are attractive to the user. Specifically, the answering unit receives a candidate list of new products from the collection unit, the user's emotion estimation results (emotion label and score), user attribute vector, purchase history tensor, and question text from the user as input tensors to a natural language generation model (e.g., transformer-based large language model). The answering unit dynamically sets prompts and control tokens for the generative AI according to the emotion label, instructing the AI to generate “detailed and polite answers” when relaxed, “concise and easy-to-understand answers” when stressed, and “answers emphasizing visually attractive expressions and emotional vocabulary” when excited. Examples of AI inputs include new product ID, category label, user attribute vector, purchase history tensor, question text, emotion label, and emotion score. The AI model analyzes these inputs and outputs answer texts about new products optimized for the emotional state (e.g., relaxed: “This new product uses high-quality materials and is designed with attention to detail.”/stressed: “This new product is easy to use.”/excited: “This new product features vibrant colors and a unique design.”) as natural language text. Examples of outputs include answer text (UTF-8 text), answer style label, and generation confidence score. As a subsequent process, the generated answer text can be displayed in a chat UI or FAQ page, and user reactions and feedback can be collected to perform answer text regeneration in a loop control. The technical effect is that emotion-linked new product answer generation by the answering unit enables automatic generation of expressions optimized for the user's psychological state and situation, greatly improving answer comprehension, appeal, and user satisfaction compared to conventional uniform answer generation, resulting in increased purchase motivation, longer site visits, and reduced churn rate. Application fields include new product chatbots for e-commerce sites, automated customer support, automatic FAQ response, and personalized answer generation for online counseling and educational support systems. These processes are technically significant in that they are realized by the collaboration of computer-based high-dimensional emotion estimation, rule-based control, and natural language generation models, which differ from simple human emotion reading and manual expression switching.

The generation unit is capable of estimating the user's emotions and generating installation images of new products that the user may be interested in, based on the estimated emotions. For example, when the user is relaxed, the generation unit generates detailed installation images of new products. When the user is feeling stressed, the generation unit can generate concise installation images of new products. Furthermore, when the user is excited, the generation unit can generate visually appealing installation images of new products. In this way, by generating installation images of new products based on the user's emotions, the generation unit can provide installation images that are attractive to the user. Specifically, the generation unit receives a candidate list of new products from the collection unit, the user's emotion estimation results (emotion label and score), user attribute vector, purchase history tensor, room image tensor, and furniture image tensor as input tensors to an image generation AI (e.g., conditional diffusion model or GAN). The generation unit dynamically sets prompts and control tokens for the generative AI according to the emotion label, instructing the AI to generate “installation images emphasizing detailed layout and color tone” when relaxed, “installation images expressing only the key points concisely” when stressed, and “visually attractive installation images with vibrant colors and dynamic effects” when excited. Examples of AI inputs include new product ID, category label, user attribute vector, purchase history tensor, room image tensor, furniture image tensor, emotion label, and emotion score. The AI model analyzes these inputs and generates installation images of new products optimized for the emotional state. Examples of outputs include installation images (PNG/JPEG format, Base64 encoded), generation style label, and generation confidence score. As a subsequent process, the generated images can be presented to the user, and user reactions and feedback can be collected to perform image regeneration in a loop control. The technical effect is that emotion-linked new product installation image generation by the generation unit greatly improves personalization, image accuracy, and appeal optimized for the user's psychological state and situation, compared to conventional uniform image generation, resulting in increased purchase motivation, decision support, longer site visits, and reduced churn rate. Application fields include new product installation simulation for furniture and home appliance e-commerce sites, new product proposals for home renovation, and personalized proposals for interior design. These processes are technically significant in that they are realized by the collaboration of computer-based high-dimensional emotion estimation, rule-based control, and image generation models, which differ from simple human emotion reading and manual image editing.

The collection unit is capable of estimating the user's emotions and collecting information about new products that the user may be interested in, based on the estimated emotions. For example, when the user is relaxed, the collection unit collects detailed information about new products. When the user is feeling stressed, the collection unit can collect concise information about new products. Furthermore, when the user is excited, the collection unit can collect visually appealing information about new products. In this way, by collecting information about new products based on the user's emotions, the collection unit can shape product description text that is attractive to the user. Specifically, the collection unit receives the user's emotion estimation results (emotion label and score) from an emotion estimation model (e.g., multimodal emotion classification neural network) and utilizes these as control parameters for a new product information collection AI (e.g., collaborative filtering or embedding-based recommendation model). According to the emotion label, the collection unit dynamically adjusts the granularity and priority of new product information collection, prioritizing “detailed information including specifications and usage scenes” when relaxed, “concise information summarizing only the key points” when stressed, and “information including visually appealing images and emotional descriptions” when excited. Examples of AI inputs include purchase history tensor, category one-hot vector, emotion label, emotion score, and user attribute vector. The AI model analyzes these inputs and outputs a new product information list optimized for the emotional state (e.g., with detailed information, concise information, or emphasis on attractiveness). Examples of outputs include new product information list (JSON format), information granularity label, and collection confidence score. As a subsequent process, the shaping unit receives the new product information list and uses it for product description text generation. The technical effect is that emotion-linked new product information collection by the collection unit greatly improves new product information collection, personalization, recommendation accuracy, and user experience optimized for the user's psychological state and situation, compared to conventional uniform information collection. Application fields include new product recommendation for e-commerce sites, customer analysis for retail stores, and new product proposals for subscription services. These processes are technically significant in that they realize automated new product information collection flows by computer-based high-dimensional emotion estimation, rule-based branching, and automation, which differ from simple human surveys and manual information collection.

The shaping unit is capable of shaping product description text for new products that the user may be interested in, based on the user's purchase history. For example, the shaping unit analyzes the user's past purchase tendencies and shapes product description text for related new products. The shaping unit can also prioritize shaping product description text for new products based on the user's interests. Furthermore, the shaping unit can shape product description text for new products related to specific categories based on the user's purchase history. In this way, by shaping product description text for new products based on the user's purchase history, the shaping unit can provide product description text that is attractive to the user. Specifically, the shaping unit receives a candidate list of new products, the user's purchase history tensor, and user attribute vector from the collection unit as input tensors to a natural language generation model (e.g., transformer-based large language model). The shaping unit embeds the user's past purchase tendencies and interests as vectors, generates context using a self-attention mechanism, and generates product description text optimized for each new product (e.g., “This new chair matches well with the Scandinavian furniture you previously purchased and is ideal for your living room.”). Examples of AI inputs include new product ID, category label, user attribute vector, purchase history tensor, and relevance score. The AI model analyzes these inputs and outputs product description text for new products optimized for the user's interests and purchase tendencies (e.g., “This new product is especially recommended based on your past purchase tendencies.”) as natural language text. Examples of outputs include product description text (UTF-8 text), description style label, and generation confidence score. As a subsequent process, the generated description text can be displayed on product pages or chat UIs, and user reactions and feedback can be collected to perform description text regeneration in a loop control. The technical effect is that purchase history-linked new product description text generation by the shaping unit greatly improves personalization, description accuracy, and appeal optimized for each user, compared to conventional uniform description text generation, contributing to increased purchase motivation and satisfaction. Application fields include automatic generation of new product descriptions for e-commerce sites, customized advertisement text generation, and digital signage for retail stores. These processes are technically significant in that they are realized by the collaboration of computer-based high-dimensional data analysis, rule-based control, and natural language generation models, which differ from manual description text creation by humans.

The following is a brief explanation of the processing flow of Example of the Embodiment. Specifically, the present system automatically generates personalized product descriptions, responses, and installation images for each user by linking the collection unit, shaping unit, answering unit, and generation unit. The collection unit automatically acquires various data such as user attribute information (e.g., age, gender, interests), past purchase tendencies (e.g., purchased product ID, frequency, amount), living situation, emotions, geographic information, and social media activity, and normalizes and encodes them as numerical vectors, categorical data, and time-series tensors. The shaping unit inputs the data received from the collection unit as input tensors to a natural language generation model (e.g., transformer-based large language model), and generates optimized product description text based on various control parameters such as user attributes, purchase tendencies, emotional state, product category, importance, submission timing, and relevance. The answering unit inputs the product description text output by the shaping unit, question text from the user, user attribute vector, emotion estimation results, question category, importance, submission timing, and relevance, and the natural language generation model generates the optimal answer text and returns it to the chat UI. The generation unit inputs the user's room image (RGB image tensor), dimension data, furniture image tensor, living situation vector, emotion label, geographic information vector, and social media activity vector, and a conditional image generation model (e.g., diffusion model or GAN) generates installation images optimized for each user. The output of each unit is linked as the input to the next unit, and the system as a whole can provide personalized product descriptions, responses, and installation images for each user in real time. The technical effect is that the present system enables information provision optimized for each user, greatly improving satisfaction, purchase motivation, repeat rate, overall system processing efficiency, scalability, and data management, compared to conventional uniform descriptions and manual responses or image generation. Application fields include virtual customer service for e-commerce sites, online consultation for furniture and home appliance sales, installation simulation for home renovation, and personalized recommendations for fashion e-commerce. These processes are technically significant in that they are realized by the collaboration of computer-based high-dimensional data analysis, rule-based control, and multimodal generation models, which differ from manual information provision and image generation by humans.

Step 1: The collection unit collects user attribute information and past purchase tendencies. User attribute information includes age, gender, and interests, and data such as the types, frequency, and amount of products previously purchased are also collected. Step 2: The shaping unit shapes product description text based on the information collected by the collection unit. The shaping unit uses generative AI to shape product description text based on user attribute information and past purchase tendencies. Step 3: The answering unit generates answers to user questions based on the product description text shaped by the shaping unit. The answering unit uses generative AI to generate appropriate answers to user questions and provides them in a chat format. Step 4: The generation unit generates post-purchase installation images based on the answers generated by the answering unit. The generation unit uses generative AI to generate post-purchase installation images based on photos of the user's room and dimension data. Specifically, in Step 1, the collection unit automatically acquires user attribute information (e.g., age=32, gender=female, interests=“Scandinavian interior”) and past purchase tendencies (e.g., purchased product ID=A123, frequency=twice a month, amount=20,000 yen) from databases or external APIs, and normalizes and encodes them as numerical vectors and categorical data. In Step 2, the shaping unit inputs the data received from the collection unit as input tensors (e.g., attribute vector+purchase history tensor) to a natural language generation model (e.g., transformer-based large language model) and generates product description text (e.g., “This chair features Scandinavian design and is popular among 32-year-old women”). In Step 3, the answering unit inputs the product description text output by the shaping unit and the user's question (e.g., “Can this chair be folded?”) and the natural language generation model generates an answer text (e.g., “Yes, this chair can be easily folded”) and returns it to the chat UI. In Step 4, the generation unit inputs the user's room image (RGB image tensor, e.g., 256×256×3) and dimension data (e.g., width 120 cm, depth 60 cm), and uses a conditional image generation model (e.g., diffusion model or GAN) to generate installation images in which the planned furniture is naturally composited into the room image (e.g., PNG format, Base64 encoded). The output of each step is linked as the input to the next step, and the system as a whole can provide personalized product descriptions, responses, and installation images for each user in real time. The technical effect is that the present system enables information provision optimized for each user, greatly improving satisfaction, purchase motivation, repeat rate, overall system processing efficiency, scalability, and data management, compared to conventional uniform descriptions and manual responses or image generation. Application fields include virtual customer service for e-commerce sites, online consultation for furniture and home appliance sales, installation simulation for home renovation, and personalized recommendations for fashion e-commerce. These processes are technically significant in that they are realized by the collaboration of computer-based high-dimensional data analysis, rule-based control, and multimodal generation models, which differ from manual information provision and image generation by humans.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, shaping unit, answering unit, and generation unit is implemented by at least one of, for example, the smart device 14 and the data processing apparatus 12. For example, the collection unit collects user attribute information and past purchase tendencies using the camera 42 or microphone 38B of the smart device 14, and transmits them to the data processing apparatus 12 via the control unit 46A. The shaping unit is implemented, for example, by a specific processing unit 290 of the data processing apparatus 12, and shapes product description text based on the collected data. The answering unit is implemented, for example, by the specific processing unit 290 of the data processing apparatus 12, generates answers to user questions based on the shaped product description text, and provides them in a chat format. The generation unit is implemented, for example, by the specific processing unit 290 of the data processing apparatus 12, and generates a post-purchase installation image based on a photo of the user's room and dimension data. The correspondence between each unit and the device or control unit is not limited to the above examples, and various modifications are possible.

### [Second Embodiment]

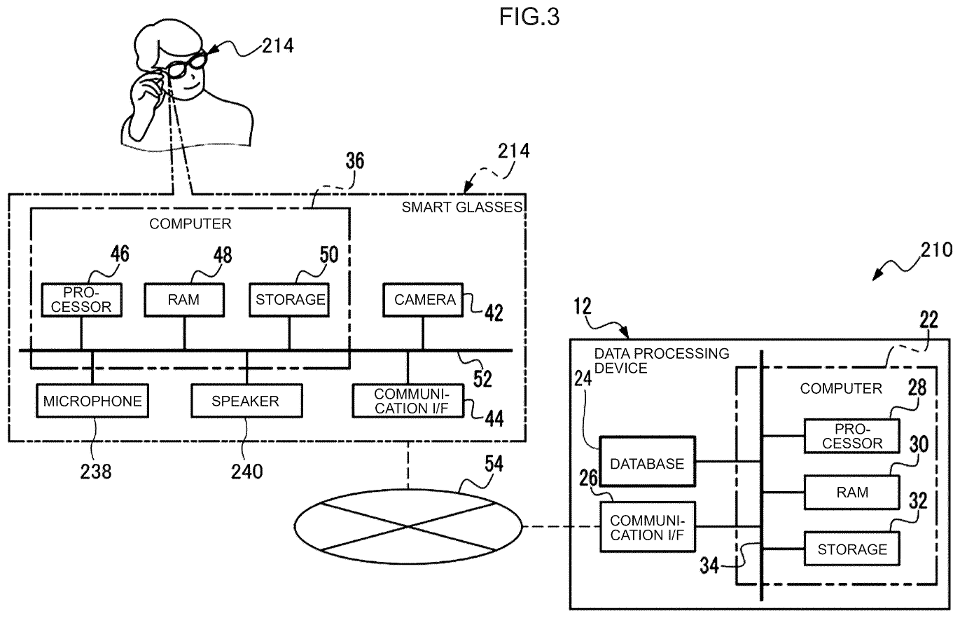

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

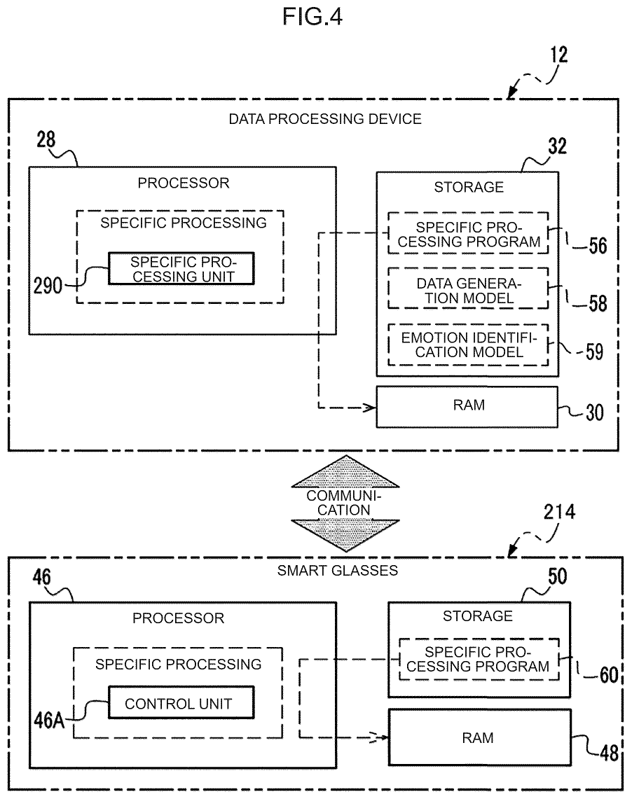

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, shaping unit, answering unit, and generation unit is implemented by at least one of, for example, the smart glasses 214 and the data processing apparatus 12. For example, the collection unit collects user attribute information and past purchase tendencies using the camera 42 or microphone 238 of the smart glasses 214, and transmits them to the data processing apparatus 12 via the control unit 46A. The shaping unit is implemented, for example, by a specific processing unit 290 of the data processing apparatus 12, and shapes product description text based on the collected data. The answering unit is implemented, for example, by the specific processing unit 290 of the data processing apparatus 12, generates answers to user questions based on the shaped product description text, and provides them in a chat format. The generation unit is implemented, for example, by the specific processing unit 290 of the data processing apparatus 12, and generates a post-purchase installation image based on a photo of the user's room and dimension data. The correspondence between each unit and the device or control unit is not limited to the above examples, and various modifications are possible.

### [Third Embodiment]

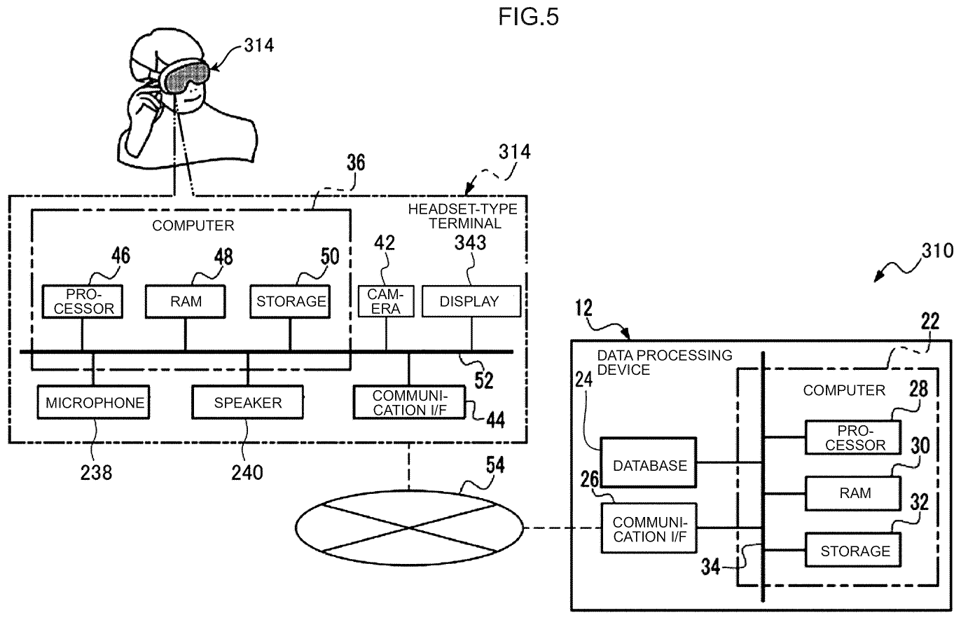

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

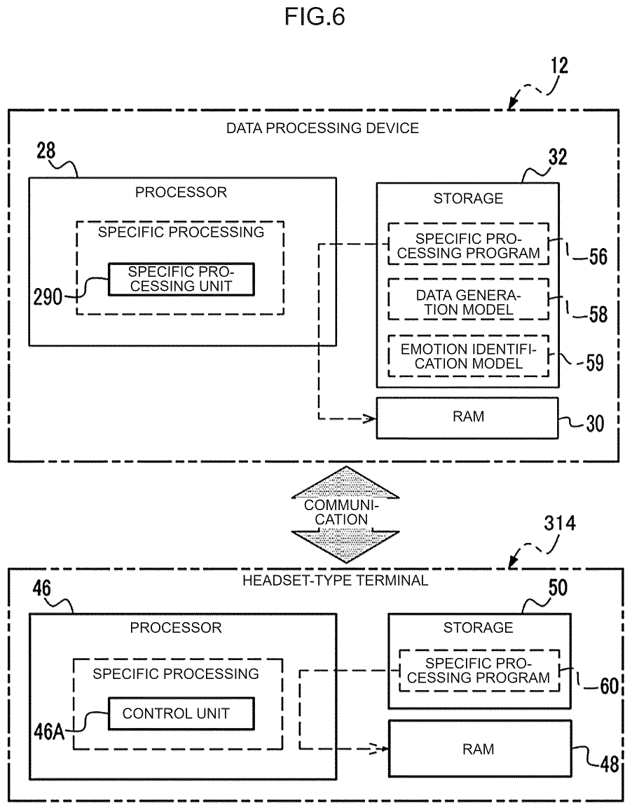

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, shaping unit, answering unit, and generation unit is implemented by at least one of, for example, the headset-type terminal 314 and the data processing apparatus 12. For example, the collection unit collects user attribute information and past purchase tendencies using the camera 42 or microphone 238 of the headset-type terminal 314, and transmits them to the data processing apparatus 12 via the control unit 46A. The shaping unit is implemented, for example, by a specific processing unit 290 of the data processing apparatus 12, and shapes product description text based on the collected data. The answering unit is implemented, for example, by the specific processing unit 290 of the data processing apparatus 12, generates answers to user questions based on the shaped product description text, and provides them in a chat format. The generation unit is implemented, for example, by the specific processing unit 290 of the data processing apparatus 12, and generates a post-purchase installation image based on a photo of the user's room and dimension data. The correspondence between each unit and the device or control unit is not limited to the above examples, and various modifications are possible.

### [Fourth Embodiment]

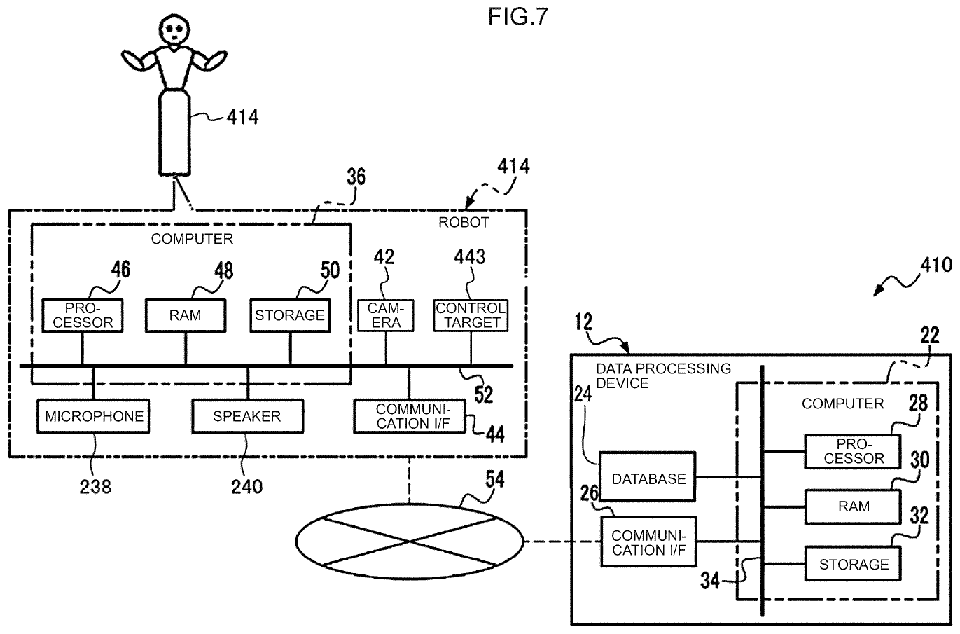

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

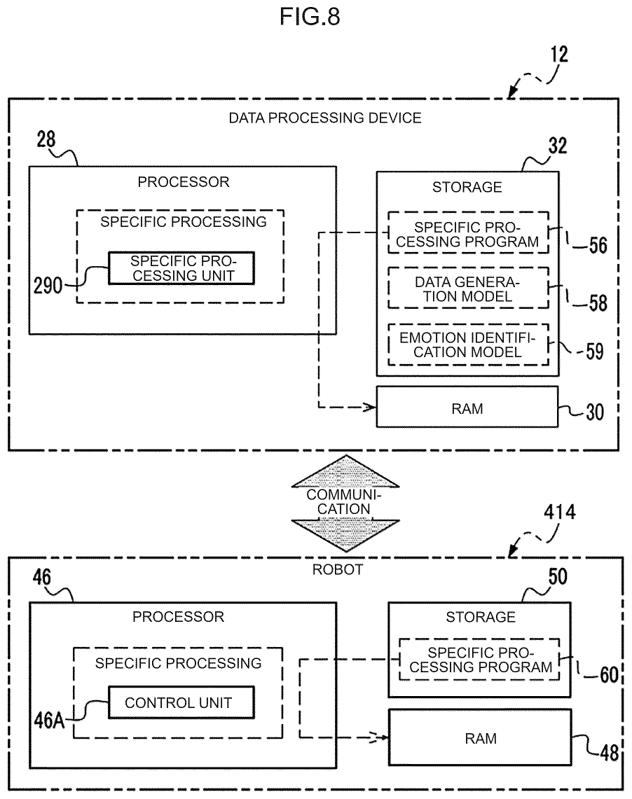

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, shaping unit, answering unit, and generation unit is implemented by at least one of, for example, the robot 414 and the data processing apparatus 12. For example, the collection unit collects user attribute information and past purchase tendencies using the camera 42 or microphone 238 of the robot 414, and transmits them to the data processing apparatus 12 via the control unit 46A. The shaping unit is implemented, for example, by a specific processing unit 290 of the data processing apparatus 12, and shapes product description text based on the collected data. The answering unit is implemented, for example, by the specific processing unit 290 of the data processing apparatus 12, generates answers to user questions based on the shaped product description text, and provides them in a chat format. The generation unit is implemented, for example, by the specific processing unit 290 of the data processing apparatus 12, and generates a post-purchase installation image based on a photo of the user's room and dimension data. The correspondence between each unit and the device or control unit is not limited to the above examples, and various modifications are possible.

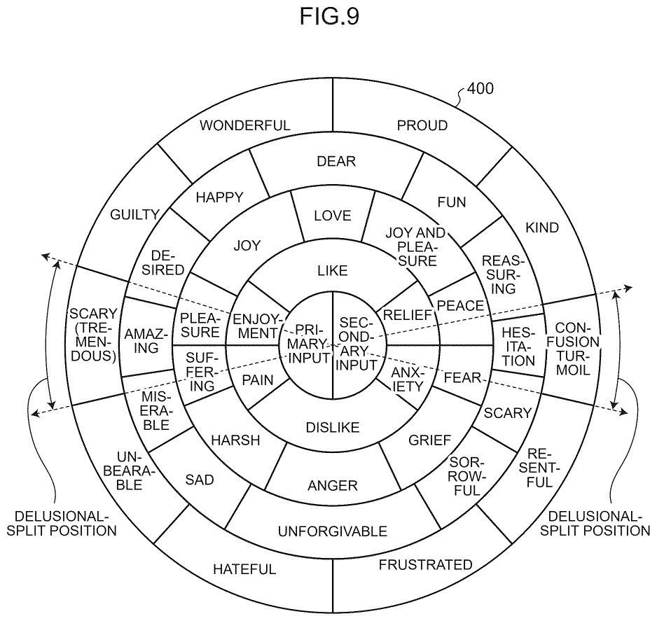

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

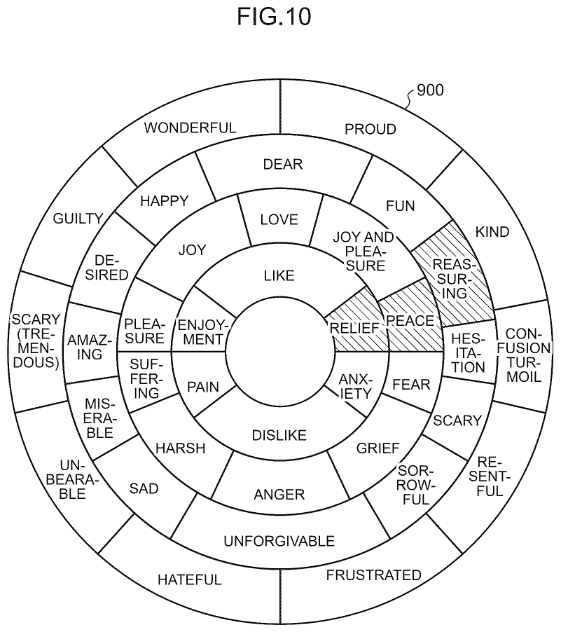

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect user attribute information and past purchase tendencies; a shaping unit configured to shape product description text based on the information collected by the collection unit; an answering unit configured to generate answers to user questions based on the product description text shaped by the shaping unit; and a generation unit configured to generate a post-purchase installation image based on the answer generated by the answering unit.
(Supplementary Note 2) The system according to Supplementary Note 1, wherein the collection unit is configured to collect attribute information such as user age, gender, interests, and data of products previously purchased by the user.
(Supplementary Note 3) The system according to Supplementary Note 1, wherein the shaping unit is configured such that a generative AI shapes the product description text based on the data collected by the collection unit.
(Supplementary Note 4) The system according to Supplementary Note 1, wherein the answering unit is configured such that a generative AI generates answers to user questions and provides them in a chat format.
(Supplementary Note 5) The system according to Supplementary Note 1, wherein the generation unit is configured such that a generative AI generates a post-purchase installation image based on a photo of the user's room and dimension data.
(Supplementary Note 6) The system according to Supplementary Note 1, wherein the generation unit is configured to provide the installation image generated by the generative AI to the user.
(Supplementary Note 7) The system according to Supplementary Note 1, wherein the collection unit is configured to estimate the user's emotions and adjust the timing of collecting attribute information based on the estimated emotions.
(Supplementary Note 8) The system according to Supplementary Note 1, wherein the collection unit is configured to analyze the user's past purchase history and select an appropriate collection method.
(Supplementary Note 9) The system according to Supplementary Note 1, wherein the collection unit is configured to perform filtering based on the user's current living situation and areas of interest when collecting attribute information.
(Supplementary Note 10) The system according to Supplementary Note 1, wherein the collection unit is configured to estimate the user's emotions and determine the priority of attribute information to be collected based on the estimated emotions.
(Supplementary Note 11) The system according to Supplementary Note 1, wherein the collection unit is configured to preferentially collect highly relevant information based on the user's geographic location information when collecting attribute information.
(Supplementary Note 12) The system according to Supplementary Note 1, wherein the collection unit is configured to analyze the user's social media activity and collect relevant information when collecting attribute information.
(Supplementary Note 13) The system according to Supplementary Note 1, wherein the shaping unit is configured to estimate the user's emotions and adjust the expression method of the product description text based on the estimated emotions.
(Supplementary Note 14) The system according to Supplementary Note 1, wherein the shaping unit is configured to adjust the level of detail of the product description text based on the importance of the product when shaping the product description text.
(Supplementary Note 15) The system according to Supplementary Note 1, wherein the shaping unit is configured to apply different shaping algorithms according to the product category when shaping the product description text.
(Supplementary Note 16) The system according to Supplementary Note 1, wherein the shaping unit is configured to estimate the user's emotions and adjust the length of the product description text based on the estimated emotions.
(Supplementary Note 17) The system according to Supplementary Note 1, wherein the shaping unit is configured to determine the priority of the product description text based on the submission timing of the product when shaping the product description text.
(Supplementary Note 18) The system according to Supplementary Note 1, wherein the shaping unit is configured to adjust the order of the product description text based on the relevance of the product when shaping the product description text.
(Supplementary Note 19) The system according to Supplementary Note 1, wherein the shaping unit is configured to adjust the order of the product description text based on the relevance of the product when shaping the product description text.
(Supplementary Note 20) The system according to Supplementary Note 1, wherein the answering unit is configured to estimate the user's emotions and adjust the expression method of the answer based on the estimated emotions.
(Supplementary Note 21) The system according to Supplementary Note 1, wherein the answering unit is configured to adjust the level of detail of the answer based on the importance of the question when generating the answer.
(Supplementary Note 22) The system according to Supplementary Note 1, wherein the answering unit is configured to apply different answering algorithms according to the question category when generating the answer.
(Supplementary Note 23) The system according to Supplementary Note 1, wherein the answering unit is configured to estimate the user's emotions and adjust the length of the answer based on the estimated emotions.
(Supplementary Note 24) The system according to Supplementary Note 1, wherein the answering unit is configured to determine the priority of the answer based on the submission timing of the question when generating the answer.
(Supplementary Note 25) The system according to Supplementary Note 1, wherein the answering unit is configured to adjust the order of the answer based on the relevance of the question when generating the answer.
(Supplementary Note 26) The system according to Supplementary Note 1, wherein the generation unit is configured to estimate the user's emotions and adjust the method of generating the installation image based on the estimated emotions.
(Supplementary Note 27) The system according to Supplementary Note 1, wherein the generation unit is configured to analyze the user's past installation history and select an optimal generation method when generating the installation image.
(Supplementary Note 28) The system according to Supplementary Note 1, wherein the generation unit is configured to customize the means of generation based on the user's current living situation when generating the installation image.
(Supplementary Note 29) The system according to Supplementary Note 1, wherein the generation unit is configured to estimate the user's emotions and determine the priority of the installation image based on the estimated emotions.
(Supplementary Note 30) The system according to Supplementary Note 1, wherein the generation unit is configured to select an optimal generation method by considering the user's geographic location information when generating the installation image.
(Supplementary Note 31) The system according to Supplementary Note 1, wherein the generation unit is configured to analyze the user's social media activity and propose means of generation when generating the installation image.

What is claimed is:

1. A system comprising:
circuitry configured to:
receive, via a packet-switched network from a client terminal, a first feature vector encoding a set of user attributes and a time-series tensor representing a historical interaction sequence associated with the user;
generate a first natural-language output by inputting the first feature vector and the time-series tensor into a data generation model comprising a Transformer-based neural network, the first natural-language output comprising a context-adapted textual description;
generate a second natural-language output by inputting the first natural-language output and a query sentence received from the client terminal into the data generation model; and
generate an output image by inputting image data received from the client terminal and a dimensional parameter vector into a conditional image generation model, and transmit the output image to the client terminal via the packet-switched network.

2. The system according to claim 1, wherein the first feature vector encodes user age, gender, and interest categories, and the time-series tensor comprises a chronologically ordered sequence of product identifiers, transaction timestamps, and transaction amounts.

3. The system according to claim 1, wherein the data generation model comprises an encoder-decoder architecture, and the circuitry is configured to generate the first natural-language output by embedding the first feature vector and the time-series tensor in a high-dimensional feature space using a self-attention mechanism.

4. The system according to claim 1, wherein the conditional image generation model comprises a diffusion model or a generative adversarial network, and the circuitry is configured to composite an object image into the image data at a position and scale determined by the dimensional parameter vector.

5. The system according to claim 1, wherein the circuitry is further configured to transmit the second natural-language output to the client terminal for display in a conversational interface, and to receive a subsequent query sentence from the client terminal in response to the second natural-language output.

6. The system according to claim 1, wherein the circuitry is further configured to input multimodal sensor data received from the client terminal into an emotion identification model comprising a multimodal classification neural network, and to obtain an emotion label and an emotion score from the emotion identification model.

7. The system according to claim 6, wherein the circuitry is further configured to adjust a timing of requesting the first feature vector from the client terminal based on the emotion label, such that a detailed attribute collection is performed when the emotion label indicates a relaxed state and a minimum attribute collection is performed when the emotion label indicates a stressed state.

8. The system according to claim 6, wherein the circuitry is further configured to select an expression style parameter for the first natural-language output based on the emotion label, such that a detailed expression style is selected when the emotion label indicates a relaxed state and a concise expression style is selected when the emotion label indicates a stressed state.

9. The system according to claim 6, wherein the circuitry is further configured to adjust a length parameter of the second natural-language output based on the emotion score.

10. The system according to claim 6, wherein the circuitry is further configured to adjust a generation priority of the output image based on the emotion label and the emotion score.

11. The system according to claim 1, wherein the circuitry is further configured to apply a clustering algorithm to the time-series tensor to extract an interaction tendency vector, and to calculate a priority score for each attribute category based on the interaction tendency vector, the priority score determining an order of attribute collection from the client terminal.

12. The system according to claim 1, wherein the circuitry is further configured to receive geographic location data from the client terminal, and to calculate a relevance score for each attribute category based on the geographic location data using a geographic clustering model, the relevance score determining a filtering condition applied to the first feature vector.

13. The system according to claim 1, wherein the circuitry is further configured to acquire social media activity data associated with the user via an external application programming interface, to extract interest categories from the social media activity data using a text classification model, and to incorporate the extracted interest categories into the first feature vector.

14. The system according to claim 1, wherein the circuitry is further configured to select, based on a category label associated with the first feature vector, one of a plurality of generation algorithms for generating the first natural-language output, the plurality of generation algorithms comprising a visually descriptive algorithm, a specification-emphasis algorithm, and a summary-emphasis algorithm.

15. The system according to claim 1, wherein the circuitry is further configured to determine a priority score for the first natural-language output based on a recency timestamp associated with the time-series tensor, and to adjust a level of detail of the first natural-language output based on the priority score.

16. The system according to claim 1, wherein the circuitry is further configured to select, based on a question category label derived from the query sentence, one of a plurality of answering algorithms for generating the second natural-language output, the plurality of answering algorithms comprising algorithms with different levels of technical detail.

17. The system according to claim 1, wherein the circuitry is further configured to receive feedback data from the client terminal indicating a spatial adjustment to the output image, and to re-input the feedback data and the image data into the conditional image generation model to generate a revised output image.

18. A system comprising:
a communication interface connected to a packet-switched network and configured to exchange data with a client terminal;
a processor;
a random-access memory;
a memory storing a data generation model obtained by performing deep learning on a neural network and a conditional image generation model; and
circuitry configured to:
receive, via the communication interface, a first feature vector encoding a set of user attributes comprising age, gender, and interest categories, and a time-series tensor representing a chronologically ordered historical interaction sequence comprising product identifiers, transaction timestamps, and transaction amounts;
generate a first natural-language output by inputting the first feature vector and the time-series tensor into the data generation model, the data generation model comprising a Transformer-based encoder-decoder architecture that embeds the first feature vector and the time-series tensor in a high-dimensional feature space using a self-attention mechanism, the first natural-language output comprising a context-adapted textual description;
generate a second natural-language output by inputting the first natural-language output and a query sentence received via the communication interface from the client terminal into the data generation model, the second natural-language output comprising a response to the query sentence;
transmit the second natural-language output via the communication interface to the client terminal for display in a conversational interface;
generate an output image by inputting image data received via the communication interface from the client terminal and a dimensional parameter vector into the conditional image generation model comprising a diffusion model, the output image comprising a composite of an object image positioned within the image data at a position and scale determined by the dimensional parameter vector; and
transmit the output image via the communication interface to the client terminal.

19. The system according to claim 18, further comprising a database connected to the processor, wherein the circuitry is further configured to store the first feature vector and the time-series tensor in the database, and to retrieve the time-series tensor from the database when generating the first natural-language output.

20. A method performed by circuitry of a system, the method comprising:
receiving, via a packet-switched network from a client terminal, a first feature vector encoding a set of user attributes and a time-series tensor representing a historical interaction sequence associated with the user;
generating a first natural-language output by inputting the first feature vector and the time-series tensor into a data generation model comprising a Transformer-based neural network, the first natural-language output comprising a context-adapted textual description;
generating a second natural-language output by inputting the first natural-language output and a query sentence received from the client terminal into the data generation model; and
generating an output image by inputting image data received from the client terminal and a dimensional parameter vector into a conditional image generation model, and transmitting the output image to the client terminal via the packet-switched network.
